(19) United States
(12) Patent Application Publication
(10) Pub. No.: US 2020/0281231 A1
(43) Pub. Date: Sep. 10, 2020

(54) DAIRY MINERALS AS A MOUTHFEEL ENHANCER AND FLAVOR MODIFER

(71) Applicant: PepsiCo, Inc., Purchase, NY (US)

(72) Inventors: Christopher Bando, Purchase, NY (US); William Mutilangi, Croton-on-Hudson, NY (US); Laura Nattress, Tarrytown, NY (US); Rashmi Tiwari, White Plains, NY (US)

(21) Appl. No.: 16/294,548

(22) Filed: Mar. 6, 2019

(51) Int. Cl. A23L 2/60; A23L 2/54; A23L 2/385; A23L 2/66; A23L 2/56; A23L 2/06; A23L 27/20; A23L 33/16

(52) U.S. Cl. CPC A23L 2/60; A23L 2/54; A23L 2/385; A23L 2/66; A23V 2002/00; A23L 2/06; A23L 27/206; A23L 33/16; A23L 2/56

(57) ABSTRACT

This disclosure provides a novel beverage composition with enhanced mouthfeel. The beverage composition can comprise a dairy mineral composition. Methods of preparing beverage compositions with enhanced mouthfeel are also disclosed, as are methods of modifying flavor.

### FIELD

This disclosure relates to modulating flavor attributes and in particular, provides a beverage composition comprising a dairy mineral composition, wherein the beverage has enhanced mouthfeel.

### BACKGROUND

Food and beverage manufacturers have been interested in preparing natural, lower calorie or zero-caloric beverages. Such beverages are typically prepared by replacing some or all of a nutritive sweetener such as sugar or corn syrup in the full calorie beverage with one or more non-nutritive sweeteners. However, replacing nutritive sweeteners with non-nutritive sweeteners produces beverages that are not as pleasing as their full calorie counterparts due to off-tastes including bitterness, astringency, licorice flavor, metallic taste, and/or lingering aftertastes associated with the non-nutritive sweeteners. Additionally, using non-nutritive sweeteners in beverages to reduce calories results in perceptible difference in the beverage's mouthfeel compared to an otherwise identical beverage containing one or more nutritive sweeteners, i.e. sugar. Thus, there is a need to develop methods and compositions for mitigating the off-tastes and enhancing mouthfeel and other organoleptic properties in beverages sweetened with non-nutritive/high potency sweeteners.

### BRIEF SUMMARY

This disclosure provides compositions comprising one or more dairy mineral compositions, and methods of modifying flavor attributes in beverages and other comestibles. The dairy mineral compositions can be used in various products, including beverages, beverage concentrates, and food products. In certain embodiments, the composition can be added to a beverage or food product.

In some embodiments, the present disclosure is directed to a beverage composition comprising a dairy mineral composition.

In some embodiments, the beverage composition further comprises a non-nutritive sweetener.

In particular embodiments, the non-nutritive sweetener is selected from the group consisting of a steviol glycoside, Lo Han Guo sweetener, rubusoside, siamenoside, monatin, curculin, glycyrrhizic acid, neohesperidin, dihydrochalcone, glycyrrhizin, glycyphyllin, phloridzin, trilobatin, phyllodulcin, brazzein, hernandulcin, osladin, polypodoside A, baiyunoside, pterocaryoside A and B, mukurozioside, thaumatin, monellin, mabinlins I and II, phlomisoside I, periandrin I, abrusoside A, and cyclocarioside I, mogroside IV, mogroside V, saccharin, cyclamate, aspartame, neotame, advantame, acesulfame potassium, sucralose, or combinations thereof.

In some embodiments, the dairy mineral composition comprises at least 10% by weight potassium.

In some embodiments, the dairy mineral composition is present in a concentration ranging from about 100 ppm to about 2000 ppm.

In some embodiments, the beverage composition is a carbonated beverage, a non-carbonated beverage, a fountain beverage, a frozen beverage, a frozen carbonated beverage, a fruit juice, a fruit juice-flavored drink, a fruit-flavored drink, a cola beverage, a sports drink, an energy drink, a fortified/enhanced water drink, a flavored water, a soy drink, a vegetable drink, a grain-based drink, a malt beverage, a fermented drink, a yogurt drink, kefir, a coffee beverage, a tea beverage, a dairy beverage, a smoothie drink, a caffeinated energy drink, or an alcoholic beverage. In particular embodiments, the beverage composition is a carbonated beverage.

In some embodiments, the beverage composition further comprises a nutritive sweetener.

In some embodiments, the beverage composition has fewer than about 200 calories per 8 oz. serving.

In some embodiments, the beverage composition is a beverage concentrate.

In some embodiments, the beverage composition comprises from about 1 ppm to about 400 ppm carbohydrates. In some embodiments, the beverage composition comprises from about 2 ppm to about 400 ppm protein.

In some embodiments, the present disclosure is directed to a method of preparing a beverage composition, the method comprising adding a dairy mineral composition.

In some embodiments, the present disclosure is directed to a method of modifying a flavor attribute in a beverage, the method comprising adding a dairy mineral composition to the beverage in an amount sufficient to achieve a final concentration of the dairy mineral composition in the beverage of about 100 ppm to about 2000 ppm.

### BRIEF DESCRIPTION OF THE DRAWINGS/FIGURES

The foregoing summary, as well as the following detailed description, will be better understood when read in conjunction with the appended figures. For the purpose of illustration, the figures may describe the use of specific embodiments. It should be understood, however, that this disclosure is not limited to the precise embodiments discussed or described in these figures.

FIG. 1 is a graph depicting flavor attributes that were enhanced by the dairy mineral composition described herein in an inventive lemon lime beverage comprising the dairy mineral composition versus a control beverage lacking the dairy mineral composition.

FIG. 2 is a graph depicting flavor attributes that were reduced by the dairy mineral composition described herein in an inventive lemon lime beverage comprising the dairy mineral composition versus a control beverage lacking the dairy mineral composition.

FIG. 3 is a graph depicting flavor attributes that were enhanced by the dairy mineral composition described herein in an inventive cola beverage comprising the dairy mineral composition versus a control beverage lacking the dairy mineral composition.

FIG. 4 is a graph depicting flavor attributes that were reduced by the dairy mineral composition described herein in an inventive cola beverage comprising the dairy mineral composition versus a control beverage lacking the dairy mineral composition.

FIG. 5 is a table listing the component concentrations present in a beverage at varying dairy mineral composition concentrations.

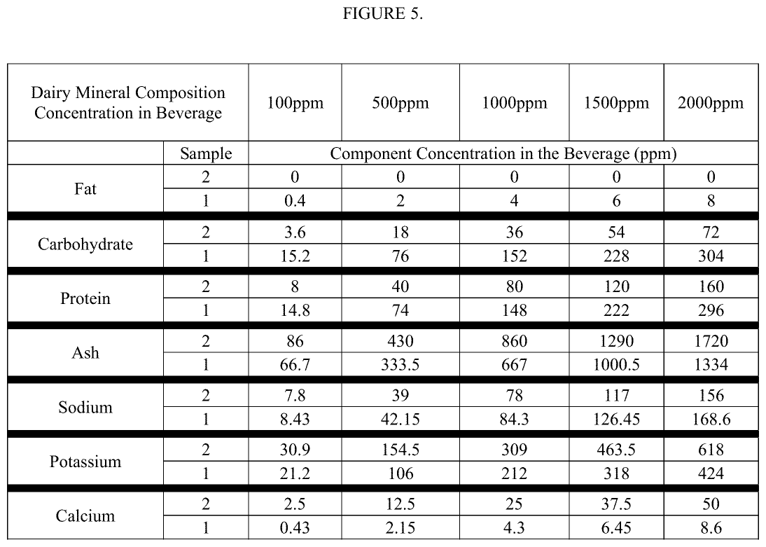

### DETAILED DESCRIPTION

### Definitions

The singular forms “a,” “an,” and “the” include plural referents unless the context clearly dictates otherwise.

As used herein, the term “or” is a logical disjunction (i.e., and/or) and does not indicate an exclusive disjunction unless expressly indicated as such with the terms “either,” “unless,” “alternatively,” and words of similar effect.

As used herein, the term “about” refers to ±10% of the noted value, unless otherwise specified, and unless the upper bound of the range would exceed 100% of the composition, in which case the upper limit of the range is limited to 99.9%. Thus, and by way of example only, a composition including about 10 weight percent of a given ingredient could have from 9 to 11 weight percent of the compound. Similarly, a composition including about 95 weight percent of a given ingredient could have from 85.5 to 99.9 weight percent of the ingredient in the composition.

The term “dairy minerals” as used herein refers to the dried by-product of whey production from whey or milk permeate. Dairy minerals also may be referred to as whey mineral concentrate, milk mineral concentrate or milk calcium.

The term “ash” as used herein refers to the inorganic residue remaining after moisture and organic matter have been removed from the dairy mineral composition by heating in the presence of oxidizing agents. Ash can be measured using the Official Methods of Analysis of AOAC INTERNATIONAL, 18th Ed., Methods 923.03, 900.02A or B, and 920.117, AOAC INTERNATIONAL, Gaithersburg, Md., USA, (2005). Preferably, ash is measured using the Official Methods of Analysis of AOAC INTERNATIONAL, 18th Ed., Methods 923.03, AOAC INTERNATIONAL, Gaithersburg, Md., USA, (2005).

As used herein, the term “beverage concentrate” refers to an aqueous beverage composition suitable for use in beverage preparation. Exemplary embodiments are described elsewhere in this disclosure.

As used herein, “flavor attributes” refers to a combination of taste perception, aromatic perception as it pertains to taste perception; temporal effects of taste perception, i.e., on-set and duration, off-tastes, e.g. bitterness and metallic taste, residual perception (aftertaste), and tactile perception, e.g. mouthfeel, body and thickness.

As used herein, the term “nutritive sweetener” refers generally to sweeteners which provide significant caloric content in typical usage amounts, e.g., more than about 5 calories per 8 oz. serving of a beverage.

As used herein, the term “non-nutritive sweetener” refers to all sweeteners other than nutritive sweeteners.

As used herein, a “full-calorie” beverage formulation is one fully sweetened with a nutritive sweetener.

As used herein, “mid-calorie” means having less than 80 calories per serving per 8 oz. for beverages.

As used herein, a “low-calorie beverage” has fewer than 40 calories per 8 oz. serving of beverage.

As used herein, “zero-calorie” means having less than 5 calories per serving per 8 oz. for beverages.

As used herein, a “sweetening amount” of a sweetener refers to the sweetener being present in an amount sufficient to contribute sweetness perceptible in a food product to a trained sensory panel. That is, as used here the term a “sweetening amount” means an amount or concentration that in the formulation of the food product in question causes sweetening that is perceptible to at least a majority of an expert sensory panel of the type commonly used in the food industry for making assessments of the flavor attributes of a beverage or other food.

As used herein, unless otherwise specified, the term “added,” “combined,” and terms of similar character mean that the ingredients or components referred to (e.g., one or more sweeteners, sweetness enhancers, etc.) are combined in any manner and in any order, with or without stirring.

All percentages provided in this specification are percentages by weight, unless specifically indicated otherwise.

### Dairy Mineral Compositions

The dairy mineral composition suitable for use in beverages, beverage concentrates, and foods can comprise a number of different components. Typically, the dairy mineral composition can comprise fat, one or more carbohydrates, protein, ash, and moisture. In some embodiments, the one or more carbohydrates can be lactose. In some embodiments, the ash can comprise calcium, phosphorous, potassium, sodium, zinc, magnesium and combinations thereof. In some embodiments, the dairy mineral composition can further comprise one or more organic acids.

Carbohydrate content in a dairy mineral composition can be analyzed using United States Department of Agriculture, “Energy Value of Foods” Agriculture Handbook No. 74, pp. 2-11, (1973). Elemental content in the dairy mineral compositions described herein can be analyzed using Official Methods of Analysis of AOAC INTERNATIONAL, 18th Ed., Method 984.27 and 985.01, AOAC INTERNATIONAL, Gaithersburg, Md., USA, (2005).

Fat content in the dairy mineral compositions described herein can be quantified using acid hydrolysis according to the Official Methods of Analysis of AOAC INTERNATIONAL, 18th Ed., Methods 922.06 and 954.02, AOAC INTERNATIONAL, Gaithersburg, Md., USA, (2005).

Water (moisture) content in the dairy mineral compositions described herein can be measured using Official Methods of Analysis of AOAC INTERNATIONAL, 18th Ed., Methods 925.09 and 926.08, AOAC INTERNATIONAL, Gaithersburg, Md., USA, (2005).

Protein content in the dairy minerals described herein can be analyzed using Official Methods of Analysis of AOAC INTERNATIONAL, 18th Ed., Methods 968.06 and 992.15, AOAC INTERNATIONAL, Gaithersburg, Md., USA, (2005).

In some embodiments the dairy mineral composition comprises from about 0.1% to about 1% by weight fat. In some embodiments, the dairy mineral composition comprises about 0.2% to about 0.9% fat, from about 0.3% to about 0.8% fat, from about 0.4% to about 0.7% fat, or from about 0.5% to about 0.6% by weight fat.

In some embodiments the dairy mineral composition comprises from about 0.2% to about 0.9% fat, from about 0.2% to about 0.8% fat, from about 0.2% to about 0.7% fat, from about 0.2% to about 0.6% fat, from about 0.2% to about 0.5% fat, from about 0.2% to about 0.4% fat, or from about 0.2% to about 0.3% by weight fat.

In some embodiments the dairy mineral composition comprises from about 0.2% to about 1% fat, from about 0.3% to about 1% fat, from about 0.4% to about 1% fat, from about 0.5% to about 1% fat, from about 0.6% to about 1% fat, from about 0.7% to about 1% fat, about 0.8% to about 1% fat, or from about 0.9% to about 1% by weight fat.

In some embodiments the dairy mineral composition comprises about 0.1%, 0.2%, 0.3%, 0.4%, 0.5%, 0.6%, 0.7%, 0.8%, 0.9%, or 1% by weight fat. In certain embodiments the dairy mineral composition comprises about 0.1% by weight fat. In other embodiments the dairy mineral composition comprises about 0.4% by weight fat.

In some embodiments the dairy mineral composition comprises from about 2% to about 20% by weight carbohydrates. In some embodiments, the dairy mineral composition comprises from about 5% to about 15% carbohydrates, from about 6% to about 14% carbohydrates, from about 7% to about 13% carbohydrates, from about 8% to about 12% carbohydrates, from about 9% to about 12% carbohydrates, or from about 10% to about 11% by weight carbohydrates.

In some embodiments the dairy mineral composition comprises from about 2% to about 19% carbohydrates, from about 2% to about 18% carbohydrates, from about 2% to about 17% carbohydrates, from about 2% to about 16% carbohydrates, from about 2% to about 15% carbohydrates, from about 2% to about 14% carbohydrates, from about 2% to about 13% carbohydrates, from about 2% to about 12% carbohydrates, from about 2% to about 11% carbohydrates, from about 2% to about 10% carbohydrates, from about 2% to about 9% carbohydrates, from about 2% to about 8% carbohydrates, from about 2% to about 7% carbohydrates, from about 2% to about 6% carbohydrates, or from about 2% to about 5% by weight carbohydrates.

In some embodiments the dairy mineral composition comprises from about 3% to about 20% carbohydrates, from about 4% to about 20% carbohydrates, from about 5% to about 20% carbohydrates, from about from about 6% to about 20% carbohydrates, from about 7% to about 20% carbohydrates, from about 8% to about 20% carbohydrates, from about 9% to about 20% carbohydrates, from about 10% to about 20% carbohydrates, from about 11% to about 20% carbohydrates, from about 12% to about 20% carbohydrates, from about 13% to about 20% carbohydrates, from about 14% to about 20% carbohydrates, or from about 15% to about 20% by weight carbohydrates.

In some embodiments the dairy mineral composition comprises about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight carbohydrates. In some embodiments the dairy mineral composition comprises about 4% by weight carbohydrates. In some embodiments the dairy mineral composition comprises about 15% by weight carbohydrates.

In some embodiments the dairy mineral composition comprises no more than about 20% by weight carbohydrates. In some embodiments the dairy mineral composition comprises no more than about 10% by weight carbohydrates. In some embodiments the dairy mineral composition comprises no more than about 5% by weight carbohydrates.

Protein can be present in the dairy mineral composition in an amount ranging from about 6% to about 20% by weight of the composition. In some embodiments the dairy mineral composition comprises from about 8% to about 18% protein, from about 10% to about 16% protein, or from about 12% to about 14% by weight protein.

In some embodiments the dairy mineral composition comprises from about 6% to about 19% protein, from about 6% to about 16% protein, from about 6% to about 17% protein, from about 6% to about 16% protein, from about 6% to about 15% protein, from about 6% to about 14% protein, from about 6% to about 13% protein, from about 6% to about 12% protein, from about 6% to about 11% protein, from about 6% to about 10% protein, or from about 6% to about 9% by weight protein.

In some embodiments the dairy mineral composition comprises from about 7% to about 20% protein, from about 8% to about 20% protein, from about 9% to about 20% protein, from about 10% to about 20% protein, from about 11% to about 20% protein, from about 12% to about 20% protein, from about 13% to about 20% protein, from about 14% to about 20% protein, from about 15% to about 20% protein, from about 16% to about 20% protein, from about 17% to about 20% protein, from about 18% to about 20% protein, or from about 19% to about 20% by weight protein.

In some embodiments the dairy mineral composition comprises about 6%, about 7%, about 8%, about 9%, about 10%, about 11%, about 12%, about 13%, about 14%, about 15%, about 16%, about 17%, about 18%, about 19%, or about 20% by weight protein. In some embodiments the dairy mineral composition comprises about 8% by weight protein. In some embodiments the dairy mineral composition comprises about 14% by weight protein.

In some embodiments the dairy mineral composition comprises at least about at least about 6%, at least about 7%, at least about 8%, at least about 9%, at least about 10%, at least about 11%, at least about 12%, at least about 13%, or at least about 14% by weight protein. In some embodiments the dairy mineral composition comprises at least about 8% by weight protein. In other embodiments the dairy mineral composition comprises at least about 14% by weight protein.

Typically, the dairy mineral composition comprises from about 55% to about 95% by weight ash. In some embodiments, the ash can comprise elements including, but not limited to, calcium, phosphorous, potassium, sodium, zinc, magnesium or combinations thereof. The weight percent of these elements is a percent weight of the total dairy mineral composition. In some embodiments the dairy mineral composition comprises from about 60% to about 90% ash, from about 65% to about 85% ash, or from about 70% to about 75% by weight ash.

In some embodiments the dairy mineral composition comprises from about 55% to about 90% ash, from about 55% to about 85% ash, from about 55% to about 80% ash, from about 55% to about 75% ash, from about 55% to about 70% ash, from about 55% to about 65% ash, or from about 55% to about 60% by weight ash.

In some embodiments the dairy mineral composition comprises from about 60% to about 95% ash, from about 65% to about 95% ash, from about 70% to about 95% ash, from about 75% to about 90% ash, from about 80% to about 95% ash, from about 85% to about 95% ash, or from about 90% to about 95% by weight ash.

In some embodiments the dairy mineral composition comprises about 55%, about 60%, about 65%, about 70%, about 75%, about 80%, about 85%, about 90%, or about 95% by weight ash. In some embodiments the dairy mineral composition comprises about 65% by weight ash. In some embodiments the dairy mineral composition comprises about 82% by weight ash.

In some embodiments the dairy mineral composition comprises from about 2% to about 20% by weight lactose. In some embodiments the dairy mineral composition comprises from about 5% to about 15% lactose, from about 6% to about 14% lactose, from about 7% to about 13% lactose, from about 8% to about 12% lactose, or from about 9% to about 11% by weight lactose.

In some embodiments the dairy mineral composition comprises from about 2% to about 19% lactose, from about 2% to about 18% lactose, from about 2% to about 17% lactose, from about 2% to about 16% lactose, from about 2% to about 15% lactose, from about 2% to about 14% lactose, from about 2% to about 13% lactose, from about 2% to about 12% lactose, from about 2% to about 11% lactose, from about 2% to about 10% lactose, from about 2% to about 9% lactose, from about 2% to about 8% lactose, from about 2% to about 7% lactose, from about 2% to about 6% lactose, or from about 2% to about 5% by weight lactose.

In some embodiments the dairy mineral composition comprises from about 3% to about 20% lactose, from about 4% to about 20% lactose, from about 5% to about 20% lactose, from about from about 6% to about 20% lactose, from about 7% to about 20% lactose, from about 8% to about 20% lactose, from about 9% to about 20% lactose, from about 10% to about 20% lactose, from about 11% to about 20% lactose, from about 12% to about 20% lactose, from about 13% to about 20% lactose, from about 14% to about 20% lactose, or from about 15% to about 20% by weight lactose.

In some embodiments the dairy mineral composition comprises about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight lactose. In some embodiments the dairy mineral composition comprises about 5% by weight lactose. In some embodiments the dairy mineral composition comprises about 16% by weight lactose.

In some embodiments the dairy mineral composition comprises from about 0.1% to about 5% by weight calcium. In some embodiments the dairy mineral composition comprises from about 0.5% to about 4.5% calcium, from about 1% to about 4% calcium, from about 1.5% to about 3.5% calcium, or from about 2% to about 3% by weight calcium.

In some embodiments the dairy mineral composition comprises from about 0.1% to about 4.5% calcium, from about 0.1% to about 4% calcium, from about 0.1% to about 3.5% calcium, from about 0.1% to about 3% calcium, from about 0.1% to about 2.5% calcium, from about 0.1% to about 2% calcium, from about 0.1% to about 1.5% calcium, from about 0.1% to about 1% calcium, or from about 0.1% to about 0.5% by weight calcium.

In some embodiments the dairy mineral composition comprises from about 0.5% to about 5% calcium, from about 1% to about 5% calcium, from about 1.5% to about 5% calcium, from about 2% to about 5% calcium, from about 2.5% to about 5% calcium, from about 3% to about 5% calcium, from about 3.5% to about 5% calcium, from about 4% to about 5% calcium, or from about 4.5% to about 5% calcium.

In some embodiments the dairy mineral composition comprises about 0.1%, about 0.5%, about 1%, about 1.5%, about 2%, about 2.5%, about 3%, about 3.5%, about 4%, about 4.5%, or about 5% by weight calcium. In some embodiments the dairy mineral composition comprises about 0.4% by weight calcium. In some embodiments the dairy mineral composition comprises about 2.5% by weight calcium.

In some embodiments the dairy mineral composition comprises no more than about 15% by weight calcium. In some embodiments the dairy mineral composition comprises no more than about 10% by weight calcium. In some embodiments the dairy mineral composition comprises no more than about 5% by weight calcium. In some embodiments the dairy mineral composition comprises no more than about 3% by weight calcium.

In some embodiments the dairy mineral composition further comprises phosphorus. In some embodiments the dairy mineral composition comprises from about 0.1% to about 5% by weight phosphorus. In some embodiments the dairy mineral composition comprises from about 0.5% to about 4.5% phosphorus, from about 1% to about 4% phosphorus, from about 1.5% to about 3.5% phosphorus, or from about 2% to about 3% by weight phosphorus.

In some embodiments the dairy mineral composition comprises from about 0.1% to about 4.5% phosphorus, from about 0.1% to about 4% phosphorus, from about 0.1% to about 3.5% phosphorus, from about 0.1% to about 3% phosphorus, from about 0.1% to about 2.5% phosphorus, from about 0.1% to about 2% phosphorus, from about 0.1% to about 1.5% phosphorus, from about 0.1% to about 1% phosphorus, or from about 0.1% to about 0.5% by weight phosphorus.

In some embodiments the dairy mineral composition comprises from about 0.5% to about 5% phosphorus, from about 1% to about 5% phosphorus, from about 1.5% to about 5% phosphorus, from about 2% to about 5% phosphorus, from about 2.5% to about 5% phosphorus, from about 3% to about 5% phosphorus, from about 3.5% to about 5% phosphorus, from about 4% to about 5% phosphorus, or from about 4.5% to about 5% phosphorous.

In some embodiments the dairy mineral composition comprises about 0.1%, about 0.5%, about 1%, about 1.5%, about 2%, about 2.5%, about 3%, about 3.5%, about 4%, about 4.5%, or about 5% by weight phosphorus. In some embodiments the dairy mineral composition comprises about 0.4% by weight phosphorus. In some embodiments the dairy mineral composition comprises about 1.1% by weight phosphorus.

In some embodiments the dairy mineral composition comprises no more than about 5% by weight phosphorus. In some embodiments the dairy mineral composition comprises no more than about 2% by weight phosphorus. In some embodiments the dairy mineral composition comprises no more than about 1% by weigh phosphorus.

In some embodiments the dairy mineral composition further comprises potassium. In some embodiments the dairy mineral composition comprises from about 10% to about 40% by weight potassium. In some embodiments the dairy mineral composition comprises from about 12% to about 38% potassium, from about 14% to about 36% potassium, from about 16% to about 34% potassium, from about 18% to about 32% potassium, from about 20% to about 30% potassium, from about 22% to about 28% potassium, or from about 24% to about 26% by weight potassium.

In some embodiments the dairy mineral composition comprises from about 10% to about 38% potassium, from about 10% to about 36% potassium, from about 10% to about 34% potassium, from about 10% to about 32% potassium, from about 10% to about 30% potassium, from about 10% to about 28% potassium, from about 10%, to about 26% potassium, from about 10% to about 24% potassium, from about 10% to about 22% potassium, from about 10% to about 20% potassium, from about 10% to about 18% potassium, from about 10% to about 16% potassium, from about 10% to about 14% potassium, or from about 10% to about 12% by weight potassium.

In some embodiments the dairy mineral composition comprises from about 12% to about 40% potassium, from about 14% to about 40% potassium, from about 16% to about 40% potassium, from about 18% to about 40% potassium, from about 20% to about 40% potassium, from about 22% to about 40% potassium, from about 24% to about 40% potassium, from about 26% to about 40% potassium, from about 28% to about 40% potassium, from about 30% to about 40% potassium, from about 32% to about 40% potassium, from about 34% to about 40% potassium, from about 36% to about 40% potassium, or from about 38% to about 40% by weight potassium.

In some embodiments the dairy mineral composition comprises about 10%, about 11%, about 12, about 13%, about 14%, about 15%, about 16%, about 17%, about 18%, about 19%, or about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40% by weight potassium.

In some embodiments the dairy mineral composition comprises about 30% by weight potassium. In some embodiments the dairy mineral composition comprises about 21% by weight potassium.

In some embodiments the dairy mineral composition comprises at least 10% by weight potassium. In some embodiments the dairy mineral composition comprises at least 15% by weight potassium. In some embodiments the dairy mineral composition comprises at least 20% by weight potassium.

In some embodiments the dairy mineral composition further comprises sodium. In some embodiments the dairy mineral composition comprises from about 5% to about 15% by weight sodium. In some embodiments the dairy mineral composition comprises from about 6% to about 14% sodium, from about 7% to about 13% sodium, from about 8% to about 12% sodium, or from about 9% to about 11% by weight sodium.

In some embodiments the dairy mineral composition comprises from about 5% to about 14% sodium, from about 5% to about 13% sodium, from about 5% to about 12% sodium, from about 5% to about 11% sodium, from about 5% to about 10% sodium, from about 5% to about 9% sodium, from about 5%, about to 8% sodium, from about 5% to about 7% sodium, or from about 5% to about 6% by weight sodium.

In some embodiments the dairy mineral composition comprises from about 6% to about 15% sodium, from about 7% to about 15% sodium, from about 8% to about 15% sodium, from about 9% to about 15% sodium, from about 10% to about 15% sodium, from about 11% to about 15% sodium, from about 12% to about 15% sodium, from about 13% to about 15% sodium, or from about 14% to about 15% by weight sodium.

In some embodiments the dairy mineral composition comprises about 5%, about 6%, about 7%, about 8%, about 9%, about 10%, about 11%, about 12%, about 13%, about 14%, or about 15% by weight sodium. In some embodiments the dairy mineral composition comprises about 8.5% sodium. In some embodiment the dairy mineral composition comprises about 8% by weight sodium.

In some embodiments the dairy mineral composition comprises at least about 3% by weight sodium. In some embodiments the dairy mineral composition comprises at least about 5% by weight sodium. In some embodiments the dairy mineral composition comprises at least about 7% by weight sodium.

In some embodiments the dairy mineral composition further comprises moisture. In some embodiments the dairy mineral composition comprises from about 2% to about 8% by weight moisture. In some embodiments the dairy mineral composition comprises about 2%, about 2.25%, about 2.5%, about 2.75%, about 3%, about 3.25%, about 3.5%, about 3.75%, about 4%, about 4.25%, about 4.5%, about 4.75%, about 5%, about 5.5%, about 6%, about 6.5%, about 7%, about 7.5%, or about 8% by weight moisture. In some embodiments the dairy mineral composition comprises about 4.5%% by weight moisture. In some embodiments the dairy mineral composition comprises about 3.25% by weight moisture.

In some embodiments the dairy mineral composition comprises no more than about 6% by weight moisture. In some embodiments the dairy mineral composition comprises no more than about 5% by weight moisture. In some embodiments the dairy mineral composition comprises no more than about 4% by weight moisture. In some embodiments the dairy mineral composition comprises no more than about 3.5% by weight moisture. In some embodiments the dairy mineral composition comprises no more than about 3% by weight moisture.

In some embodiments the dairy mineral composition comprises from about 2% to about 20% by weight carbohydrates, from about 6% to about 20% by weight protein, from about 55% to about 95% by weight ash, and from about 2% to about 8% by weight moisture.

In some embodiments the dairy mineral composition comprises about 4% by weight carbohydrates, about 8% by weight protein, about 82% by weight ash, and about 4.5% by weight moisture.

In some embodiments, and in addition to any of the other components described above, the dairy mineral composition can comprise an organic acid. Suitable organic acids include, but are not limited to, citric acid, lactic acid, acetic acid, oxalic acid, formic acid, and combinations thereof.

In some embodiments the dairy mineral composition comprises about 5% by weight lactose, about 8% by weight protein, about 2.5% by weight calcium, about 0.4% by weight phosphorus, about 30% by weight potassium, about 8% by weight sodium, and about 4.5% by weight moisture.

In some embodiments the dairy mineral composition comprises about 0.4% by weight fat, about 15% by weight carbohydrates, about 15% by weight protein, about 65% by weight ash, and about 3% by weight moisture.

In some embodiments the dairy mineral composition comprises about 0.4% by weight fat, about 15% by weight lactose, about 15% by weight protein, about 8.5% sodium, about 21% by weight potassium, about 1.1% by weight phosphorus, about 0.4% by weight calcium, and about 3% by weight moisture.

In some embodiments the dairy mineral composition comprises from about 2% to about 20% by weight carbohydrates and from about 6% to about 20% by weight protein.

In some embodiments the dairy mineral composition comprises about 5% by weight lactose and about 8% by weight protein.

In some embodiments the dairy mineral composition comprises about 0.4% by weight fat, about 15% by weight lactose, and about 15% by weight protein.

In some embodiments the dairy mineral composition comprises at least about 6% by weight protein, no more than 8% by weight moisture, no more than 15% by weight calcium, no more than 5% by weight phosphorus, at least 10% by weight potassium and at least about 3% by weight sodium.

In some embodiments the dairy mineral composition comprises at least about 6% by weight protein, no more than 15% by weight calcium, no more than 5% by weight phosphorus, at least 10% by weight potassium, and at least about 3% by weight sodium.

In some embodiments the dairy mineral composition comprises at least about 6% by weight protein, at least 10% by weight potassium, and at least about 3% by weight sodium.

In some embodiments the dairy mineral composition comprises no more than 15% by weight calcium and no more than 5% by weight phosphorus.

In some embodiments the dairy mineral composition comprises from about 0.1% to about 5% by weight calcium, about 0.1% to about 5% by weight phosphorus, from about 10% to about 40% by weight potassium, and about 5% to about 15% by weight sodium.

In some embodiments the dairy mineral composition comprises at least about 30% by weight ash and no more than 20% by weight carbohydrates.

### Beverages

In addition to the dairy mineral composition described above, the present disclosure also provides a beverage composition. In some embodiments the beverage composition comprises a dairy mineral composition. In some embodiments the beverage composition does not comprise a dairy mineral composition.

In some embodiments, the beverage can be selected from the group consisting of a carbonated beverage, a non-carbonated beverage, a fountain beverage, a frozen carbonated beverage, a powdered concentrate, a liquid concentrate, a fruit juice, a fruit juice-flavored drink, a fruit-flavored drink, a sports drink, an energy drink, a fortified/enhanced water drink, a soy drink, a vegetable drink, a grain-based drink, a malt beverage, a fermented drink, a yogurt drink, kefir, a coffee beverage, a tea beverage, a dairy beverage, and mixtures of any of them.

In some embodiments, the beverage can be a carbonated cola beverage. In some embodiments the beverage can be a carbonated lemon-lime beverage.

In some embodiments, the beverage can have fewer than about 200 calories per 8 oz. serving, fewer than about 150 calories per 8 oz. serving, fewer than about 100 calories per 8 oz. serving, fewer than about 70 calories per 8 oz. serving, fewer than about 50 calories per 8 oz. serving, fewer than about 10 calories per 8 oz. serving, or fewer than about 5 calories per 8 oz. serving.

In some embodiments, the dairy mineral composition can be present in the beverage at a concentration ranging from about 100 ppm to about 2000 ppm. In some embodiments, the dairy mineral composition can be present in the beverage at a concentration ranging from about 500 ppm to about 1500 ppm. In some embodiments, the dairy mineral composition can be present in the beverage at a concentration ranging from about 150 to about 1950, from about 200 to about 1900, from about 250 to about 1850, from about 300 to about 1800, from about 350 to about 1750, from about 400 to about 1700, from about 450 to about 1650, from about 500 to about 1600, 550 ppm to about 1550 ppm, from about 600 ppm to about 1450 ppm, from about 650 ppm to about 1400 ppm, from about 700 ppm to about 1350 ppm, from about 750 ppm to about 1300 ppm, or from about 800 ppm to about 1250, from about 850 to about 1200, from about 850 ppm to about 1150 ppm, from about 900 ppm to about 1100 ppm, or from about 950 to about 1050.

In some embodiments, the dairy mineral composition can be present in a beverage composition at a concentration ranging from about 100 ppm to about 1900, from about 100 ppm to about 1800 ppm, from about 100 ppm to about 1700 ppm, from about 100 ppm to about 1600 ppm, from about 100 ppm to about 1500 ppm, from about, 100 ppm to about 1400 ppm, from about 100 ppm to about 1300 ppm, from about 100 ppm to about 1200 ppm, from about 100 ppm to about 1100 ppm, from about 100 ppm to about 1000 ppm, from about 100 ppm to about 900 ppm, from about 100 ppm to about 800 ppm, from about 100 ppm to about 700 ppm, from about 100 ppm to about 600 ppm, or from about 100 ppm to about 500 ppm.

In some embodiments, the dairy mineral composition can be present in the beverage at a concentration ranging from about from about 200 ppm to about 2000 ppm, from about 300 ppm to about 2000 ppm, from about 400 ppm to about 2000 ppm, from about 500 ppm to about 2000 ppm, from about 600 ppm to about 2000 ppm, from about 700 ppm to about 2000 ppm, from about 800 ppm to about 2000 ppm, from about 900 ppm to about 2000 ppm, from about 1000 ppm to about 2000 ppm, from about 1100 ppm to about 2000 ppm, from about 1200 ppm to about 2000 ppm, from about 1300 ppm to about 2000 ppm, from about 1400 ppm to about 2000 ppm, from about 1500 ppm to about 2000 ppm, from about 1600 ppm to about 2000 ppm, from about 1700 ppm to about 2000 ppm, from about 1800 ppm to about 2000 ppm, or from about 1900 ppm to about 2000 ppm.

In other embodiments the dairy mineral composition can be present in the beverage at a concentration of about 100 ppm, 150 ppm, 200 ppm, 250 ppm, 300 ppm, 350 ppm, 400 ppm, 450 ppm, 500 ppm, about 550 ppm, about 600 ppm, about 650 ppm, about 700 ppm, about 750 ppm, about 800 ppm, about 850 ppm, about 900 ppm, about 950 ppm, about 1000 ppm, about 1050 ppm, about 1100 ppm, about 1150 ppm, about 1200 ppm, about 1250 ppm, about 1300 ppm, about 1350 ppm, about 1400 ppm, about 1450 ppm, about 1500 ppm, about 1550 ppm, about 1600 ppm, about 1650 ppm, about 1700 ppm, about 1750 ppm, about 1800 ppm, about 1850 ppm, about 1900 ppm or any ranges between any of these values. In particular embodiments the dairy mineral composition can be present in a beverage composition at a concentration of about 100 ppm. In particular embodiments the dairy mineral composition can be present in a beverage composition at a concentration of about 300 ppm. In particular embodiments the dairy mineral composition can be present in a beverage composition at a concentration of about 500 ppm. In particular embodiments the dairy mineral composition can be present in a beverage composition at a concentration of about 1000 ppm. In particular embodiments the dairy mineral composition can be present in a beverage composition at a concentration of about 1500 ppm. In particular embodiments the dairy mineral composition can be present in a beverage composition at a concentration of about 2000 ppm.

In some embodiments the beverage composition can comprise from about 0.01 ppm to about 15 ppm fat. In some embodiments, the beverage comprising a dairy mineral composition comprises from about 0.05 ppm to about 14 ppm, from about 0.1 to about 13 ppm, from about 0.5 to about 12 ppm, 0.6 ppm to about 13 ppm fat, from about 0.7 ppm to about 12 ppm fat, from about 0.8 ppm to about 11 ppm fat, from about 0.9 ppm to about 10 ppm fat, from about 1 ppm to about 9 ppm fat, from about 2 ppm to about 8 ppm fat, from about 3 ppm to about 7 ppm fat, or from about 4 ppm to about 6 ppm fat.

In some embodiments the beverage composition can comprise from about 0.01 ppm to about 14 ppm fat, from about 0.01 to about 13 ppm fat, from about 0.01 to about 12 ppm fat, from about 0.01 to about 11 ppm fat, from about 0.01 to about 10 ppm fat, from about 0.01 to about 9 ppm fat, from about 0.01 to about 8 ppm fat, from about 0.01 to about 7 ppm fat, from about 0.01 to about 6 ppm fat, from about 0.01 to about 5 ppm fat, from about 0.01 to about 4 ppm fat, from about 0.01 to about 3 ppm fat, from about 0.01 to about 2 ppm fat, from about 0.01 to about 1 ppm fat, from about 0.01 to about 0.5 ppm fat, from about 0.01 to about 0.1 ppm fat, or from about 0.01 to about 0.05 ppm fat.

In some embodiments the beverage composition comprises from about 0.05 to about 15 ppm fat, from about 0.1 to about 15 ppm fat, 0.3 to about 15 ppm fat, from about 0.4 to about 15 ppm fat, from about 0.5 to about 15 ppm fat, from about 0.6 ppm to about 15 ppm fat, from about 0.7 to about 15 ppm fat, from about 0.8 to about 15 ppm fat, from about 0.9 ppm to about 15 ppm fat, from about 1 ppm to about 15 ppm fat, from about 2 ppm to about 15 pm fat, from about 3 ppm to about 15 ppm fat, from about 4 ppm to about 15 ppm fat, from about 5 ppm to about 15 ppm fat, from about 6 ppm to about 15 ppm fat, from about 7 ppm to about 15 ppm fat, from about 8 ppm to about 15 ppm fat, from about 9 ppm to about 15 ppm fat, from about 10 ppm to about 15 ppm fat, from about 11 ppm to about 15 ppm fat, from about 12 ppm to about 15 ppm fat, from about 13 ppm to about 15 ppm fat, or from about 14 ppm to about 15 ppm fat.

In some embodiments the beverage composition comprises about 0.01 ppm, about 0.05 ppm, 0.1 ppm, about 0.2 ppm, about 0.3 ppm, about 0.4 ppm, about 0.5 ppm, about 0.6 ppm, about 0.7 ppm, about 0.8 ppm, about 0.9 ppm, about 1 ppm, about 2 ppm, about 3 ppm, about 4 ppm, about 5 ppm, about 6 ppm, about 7 ppm, about 8 ppm, about 9 ppm, about 10 ppm, about 11 ppm, about 12 ppm, about 13 ppm, about 14 ppm, or about 15 ppm fat.

In some embodiments the beverage composition comprises about 0.4 ppm fat. In some embodiments the beverage comprising a dairy mineral composition comprises about 2 ppm fat. In some embodiments the beverage comprising a dairy mineral composition comprises about 6 ppm fat. In some embodiments the beverage comprising a dairy mineral composition comprises about 8 ppm fat.

In some embodiments the beverage composition comprises from about 1 ppm to about 400 ppm carbohydrates. In some embodiments the beverage comprising a dairy mineral composition comprises about 5 ppm to about 375 ppm carbohydrates, from about 10 ppm to about 350 ppm carbohydrates, from about 15 ppm to about 325 ppm carbohydrates, from about 20 ppm to about 300 ppm carbohydrates, from about 25 ppm to about 275 ppm carbohydrates, from about 30 ppm to about 250 ppm carbohydrates, from about 35 ppm to about 225 ppm carbohydrates, from about 40 to about 200 ppm carbohydrates, from about 45 ppm to about 175 ppm carbohydrates, from about 50 ppm to about 150 ppm carbohydrates, from about 60 to about 125 ppm carbohydrates, from about 70 to about 100 ppm carbohydrates, or from about 80 ppm to about 90 ppm carbohydrates.

In some embodiments the beverage composition comprises from about 1 ppm to about 375 ppm carbohydrates, from about 1 ppm to about 350 ppm carbohydrates, from about 1 ppm to about 325 ppm carbohydrates, from about 1 ppm to about 300 ppm carbohydrates, from about 1 ppm to about 275 ppm carbohydrates, from about 1 ppm to about 250 ppm carbohydrates, from about 1 ppm to about 225 ppm carbohydrates, from about 1 ppm to about 200 ppm carbohydrates, from about 1 ppm to about 175 ppm carbohydrates, from about 1 ppm to about 150 ppm carbohydrates, from about 1 ppm to about 125 ppm carbohydrates, from about 1 ppm to about 20 ppm carbohydrates, from about 2 pm to about 90 ppm carbohydrates, from about 1 ppm to about 80 ppm carbohydrates, from about 1 ppm to about 70 ppm carbohydrates, from about 1 ppm to about 60 ppm carbohydrates, from about 1 ppm to about 50 ppm carbohydrates, from about 1 ppm to about 40 ppm carbohydrates, from about 1 ppm to about 30 ppm carbohydrates, or from about 1 ppm to about 20 ppm carbohydrates.

In some embodiments the beverage composition comprises from about from about 3 ppm to about 400 ppm carbohydrates, from about 5 ppm to about 400 ppm carbohydrates, from about 10 ppm to about 400 ppm carbohydrates, from about 15 ppm to about 400 ppm carbohydrates, from about 20 ppm to about 400 ppm carbohydrates, from about 30 ppm to about 400 ppm carbohydrates, from about 40 ppm to about 400 ppm carbohydrates, from about 50 ppm to about 400 ppm carbohydrates, from about 60 ppm to about 400 ppm carbohydrates, from about 70 ppm to about 400 ppm carbohydrates, from about 80 ppm to about 400 ppm carbohydrates, from about 90 ppm to about 400 ppm carbohydrates, from about 100 ppm to about 400 ppm carbohydrates, from about 125 ppm to about 400 ppm carbohydrates, from about 150 ppm to about 400 ppm carbohydrates, from about 175 ppm to about 400 ppm carbohydrates, from about 200 ppm to about 400 ppm carbohydrates, from about 225 ppm to about 400 ppm carbohydrates, from about 250 ppm to about 400 ppm carbohydrates, from about 275 ppm to about 400 ppm carbohydrates, from about 300 ppm to about 400 ppm carbohydrates, from about 325 ppm to about 400 ppm carbohydrates, from about 350 ppm to about 400 ppm carbohydrates, or from about 375 ppm to about 400 ppm carbohydrates.

In some embodiments the beverage composition comprises about 1 ppm, about 2 ppm, about 3 ppm, about 4 ppm, about 5 ppm, 10 ppm, about 20 ppm, about 30 ppm, about 40 ppm, about 50 pp, about 60 ppm, about 70 ppm, about 80 ppm, about 90 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, or about 400 ppm carbohydrates. In some embodiments the beverage composition comprises about 4 ppm carbohydrates. In some embodiments the beverage composition comprises about 18 ppm carbohydrates. In some embodiments the beverage composition comprises about 55 ppm carbohydrates. In some embodiments the beverage composition comprises about 70 ppm carbohydrates. In some embodiments the beverage composition comprises about 15 ppm carbohydrates. In some embodiments the beverage composition comprises about 75 ppm carbohydrates. In some embodiments the beverage composition comprises about 230 ppm carbohydrates. In some embodiments the beverage composition comprises about 300 ppm carbohydrates.

In some embodiments the beverage composition comprises from about 2 ppm to about 400 ppm protein. In some embodiments the beverage comprising a dairy mineral composition comprises from about 5 ppm to about 350 ppm protein, from about 10 ppm to about from 300 ppm protein, from about 20 ppm to about 250 ppm protein, from about 30 to about 200 ppm protein, from about 40 ppm to about 150 ppm protein, from about 50 ppm to about 100 ppm protein, from about 60 ppm to about 90 ppm protein, or from about 70 ppm to about 80 ppm protein.

In some embodiments the beverage composition comprises from about 2 ppm to about 372 ppm protein, from about 2 ppm to about 350 ppm protein, from about 2 ppm to about 322 ppm protein, from about 2 ppm to about 300 ppm protein, from about 2 ppm to about 272 ppm protein, from about 2 ppm to about 250 ppm protein, from about 2 ppm to about 222 ppm protein, from about 2 ppm to about 200 ppm protein, from about 2 ppm to about 172 ppm protein, from about 2 ppm to about 150 ppm protein, from about 2 ppm to about 122 ppm protein, from about 2 ppm to about 100 ppm protein, from about 40 pm to about 90 ppm protein, from about 2 ppm to about 80 ppm protein, from about 2 ppm to about 70 ppm protein, from about 2 ppm to about 60 ppm protein, from about 2 ppm to about 50 ppm protein, from about 2 ppm to about 40 ppm protein, from about 2 ppm to about 30 ppm protein, from about 2 ppm to about 20 ppm protein, from about 2 ppm to about 10 ppm protein, or from about 2 ppm to about 5 ppm protein.

In some embodiments the beverage composition comprises from about from about 2 ppm to about 400 ppm protein, 5 ppm to about 400 ppm protein, 10 ppm to about 400 ppm protein, from about 20 ppm to about 400 ppm protein, from about 30 ppm to about 400 ppm protein, 40 ppm to about 400 ppm protein, 50 ppm to about 400 ppm protein, from about 60 ppm to about 400 ppm protein, from about 70 ppm to about 400 ppm protein, from about 80 ppm to about 400 ppm protein, from about 90 ppm to about 400 ppm protein, from about 100 ppm to about 400 ppm protein, from about 125 ppm to about 400 ppm protein, from about 150 ppm to about 400 ppm protein, from about 175 ppm to about 400 ppm protein, from about 200 ppm to about 400 ppm protein, from about 225 ppm to about 400 ppm protein, from about 250 ppm to about 400 ppm protein, from about 275 ppm to about 400 ppm protein, from about 300 ppm to about 400 ppm protein, from about 325 ppm to about 400 ppm protein, from about 350 ppm to about 400 ppm protein, or from about 375 ppm to about 400 ppm protein.

In some embodiments the beverage composition comprises about 2 ppm, about 3 ppm, about 4 ppm, about 5 ppm, about 10 ppm, about 20 ppm, 30 ppm, about 40 ppm, about 50 pp, about 60 ppm, about 70 ppm, about 80 ppm, about 90 ppm, about 100 ppm, about 125 ppm, about 150 ppm, about 200 ppm, about 225 ppm, about 250 ppm, about 275 ppm, about 300 ppm protein, about 325 ppm, about 350 ppm, about 375 ppm, or about 400 ppm protein. In some embodiments the beverage comprising a dairy mineral composition comprises about 8 ppm protein. In some embodiments the beverage comprising a dairy mineral composition comprises about 40 ppm protein. In some embodiments the beverage comprising a dairy mineral composition comprises about 120 ppm protein. In some embodiments the beverage comprising a dairy mineral composition comprises about 160 ppm protein. In some embodiments the beverage comprising a dairy mineral composition comprises about 15 ppm protein. In some embodiments the beverage comprising a dairy mineral composition comprises about 75 ppm protein. In some embodiments the beverage comprising a dairy mineral composition comprises about 225 ppm protein. In some embodiments the beverage comprising a dairy mineral composition comprises about 300 ppm protein.

In some embodiments the beverage composition comprises from about 2 ppm to about 400 ppm lactose. In some embodiments the beverage comprising a dairy mineral composition comprises about 5 ppm to about 375 ppm lactose, from about 10 ppm to about 350 ppm lactose, from about 15 ppm to about 325 ppm lactose, from about 20 ppm to about 300 ppm lactose, from about 25 ppm to about 275 ppm lactose, from about 30 ppm to about 250 ppm lactose, from about 35 ppm to about 225 ppm lactose, from about 40 to about 200 ppm lactose, from about 45 ppm to about 175 ppm lactose, from about 50 ppm to about 150 ppm lactose, from about 60 to about 125 ppm lactose, from about 70 to about 100 ppm lactose, or from about 80 ppm to about 90 ppm lactose.

In some embodiments the beverage composition comprises from about 2 ppm to about 375 ppm lactose, from about 2 ppm to about 350 ppm lactose, from about 2 ppm to about 325 ppm lactose, from about 2 ppm to about 300 ppm lactose, from about 2 ppm to about 275 ppm lactose, from about 2 ppm to about 250 ppm lactose, from about 2 ppm to about 225 ppm lactose, from about 2 ppm to about 200 ppm lactose, from about 2 ppm to about 175 ppm lactose, from about 2 ppm to about 150 ppm lactose, from about 2 ppm to about 125 ppm lactose, from about 2 ppm to about 20 ppm lactose, from about 2 pm to about 90 ppm lactose, from about 2 ppm to about 80 ppm lactose, from about 2 ppm to about 70 ppm lactose, from about 2 ppm to about 60 ppm lactose, from about 2 ppm to about 50 ppm lactose, from about 2 ppm to about 40 ppm lactose, from about 2 ppm to about 30 ppm lactose, or from about 2 ppm to about 20 ppm lactose.

In some embodiments the beverage composition comprises from about from about 5 ppm to about 400 ppm lactose, from about 10 ppm to about 400 ppm lactose, from about 15 ppm to about 400 ppm lactose, from about 20 ppm to about 400 ppm lactose, from about 30 ppm to about 400 ppm lactose, from about 40 ppm to about 400 ppm lactose, from about 50 ppm to about 400 ppm lactose, from about 60 ppm to about 400 ppm lactose, from about 70 ppm to about 400 ppm lactose, from about 80 ppm to about 400 ppm lactose, from about 90 ppm to about 400 ppm lactose, from about 100 ppm to about 400 ppm lactose, from about 125 ppm to about 400 ppm lactose, from about 150 ppm to about 400 ppm lactose, from about 175 ppm to about 400 ppm lactose, from about 200 ppm to about 400 ppm lactose, from about 225 ppm to about 400 ppm lactose, from about 250 ppm to about 400 ppm lactose, from about 275 ppm to about 400 ppm lactose, from about 300 ppm to about 400 ppm lactose, from about 325 ppm to about 400 ppm lactose, from about 350 ppm to about 400 ppm lactose, or from about 375 ppm to about 400 ppm lactose.

In some embodiments the beverage composition comprises about 2 ppm, about 5 ppm, 10 ppm, about 20 ppm, about 30 ppm, about 40 ppm, about 50 pp, about 60 ppm, about 70 ppm, about 80 ppm, about 90 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, or about 400 ppm lactose. In some embodiments the beverage composition comprises about 4 ppm lactose. In some embodiments the beverage composition comprises about 18 ppm lactose. In some embodiments the beverage composition comprises about 55 ppm lactose. In some embodiments the beverage composition comprises about 70 ppm lactose. In some embodiments the beverage composition comprises about 15 ppm lactose. In some embodiments the beverage composition comprises about 75 ppm lactose. In some embodiments the beverage composition comprises about 230 ppm lactose. In some embodiments the beverage composition comprises about 300 ppm lactose.

In some embodiments the beverage composition comprises from about 0.2 ppm to about 75 ppm calcium. In some embodiments the beverage comprising a dairy mineral composition comprises from about 0.5 ppm to about 70 ppm calcium, from about 0.7 ppm to about 65 ppm, from about 0.8 ppm to about 60 ppm calcium, from about 0.9 ppm to about 55 ppm calcium, from about 1 ppm to about 50 ppm calcium, from about 2 ppm to about 45 ppm calcium, from about 3 ppm to about 40 ppm calcium, from about 4 ppm to about 35 ppm calcium, from about 5 ppm to about 30 ppm calcium, from about 9 ppm to about 25 ppm, or from about 10 ppm to about 20 ppm.

In some embodiments the beverage composition comprises from about 0.2 ppm to about 70 ppm calcium, from about 0.2 ppm to about 65 ppm calcium, from about 0.2 ppm to about 60 ppm calcium, from about 0.2 ppm to about 55 ppm calcium, from about 0.2 ppm to about 50 ppm calcium, from about 0.2 ppm to about 45 ppm calcium, from about 0.2 ppm to about 40 ppm calcium, from about 0.2 ppm to about 35 ppm calcium, from about 0.2 ppm to about 30 ppm calcium, from about 0.2 ppm to about 25 ppm calcium, from about 0.2 ppm to about 20 ppm calcium, from about 0.2 ppm to about 15 ppm calcium, from about 0.2 ppm to about 10 ppm calcium, from about 0.2 ppm to about 5 ppm calcium, from about 0.2 ppm to about 1 ppm calcium, or from about 0.2 ppm to about 0.5 ppm calcium.

In some embodiments the beverage composition comprises from about 0.3 ppm to about 75 ppm calcium, from about 0.4 ppm to about 75 ppm calcium, from about 0.5 ppm to about 75 ppm calcium, 0.6 ppm to about 75 ppm calcium, from about 0.7 ppm to about 75 ppm calcium, from about 0.8 ppm to about 75 ppm calcium, from about 0.9 ppm to about 75 ppm calcium, from about 1 ppm to about 75 ppm calcium, from about 5 ppm to about 75 pm calcium, from about 10 ppm to about 75 ppm calcium, from about 15 ppm to about 75 ppm calcium, from about 20 ppm to about 75 ppm calcium, from about 25 ppm to about 75 ppm calcium, from about 30 ppm to about 75 ppm calcium, from about 35 ppm to about 75 ppm calcium, from about 40 ppm to about 75 ppm calcium, from about 45 ppm to about 75 ppm calcium, from about 50 ppm to about 75 ppm calcium, from about 55 ppm to about 75 ppm calcium, from about 60 ppm to about 75 ppm calcium, from about 65 ppm to about 75 ppm calcium, or from about 70 ppm to about 75 ppm calcium.

In some embodiments the beverage composition comprises about 0.1 ppm, about 0.2 ppm, about 0.3 ppm, about 0.4 ppm, about 0.5 ppm, about 0.6 ppm, about 0.7 ppm, about 0.8 ppm, about 0.9 ppm, about 1 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, or about 75 ppm calcium.

In some embodiments the beverage composition comprises about 2.5 ppm calcium. In some embodiments the beverage comprising a dairy mineral composition comprises about 12 ppm calcium. In some embodiments the beverage composition comprises about 38 ppm calcium. In some embodiments the beverage comprising a dairy mineral composition comprises about 50 ppm calcium. In some embodiments the beverage composition comprises about 0.4 ppm calcium. In some embodiments the beverage comprising a dairy mineral composition comprises about 2 ppm calcium. In some embodiments the beverage composition comprises about 7 ppm calcium. In some embodiments the beverage comprising a dairy mineral composition comprises about 9 ppm calcium.

In some embodiments, the beverage further comprises at least one sweetener, wherein the at least one sweetener can be a nutritive sweetener, non-nutritive sweetener, or a combination thereof.

In certain embodiments the beverage can comprise a non-nutritive sweetener. In particular embodiments, the non-nutritive sweetener can be selected from the group consisting of a steviol glycoside, Lo Han Guo sweetener, rubusoside, siamenoside, monatin, curculin, glycyrrhizic acid, neohesperidin, dihydrochalcone, glycyrrhizin, glycyphyllin, phloridzin, trilobatin, phyllodulcin, brazzein, hernandulcin, osladin, polypodoside A, baiyunoside, pterocaryoside A and B, mukurozioside, thaumatin, monellin, mabinlins I and II, phlomisoside I, periandrin I, abrusoside A, and cyclocarioside I, mogroside IV, mogroside V, or combinations thereof.

In some embodiments, the non-nutritive sweetener in the beverage can be a steviol glycoside. In some embodiments, the steviol glycoside can be stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside P, rebaudioside Q, steviolbioside, dulcoside A, or a mixture of any of the foregoing. In some embodiments, the steviol glycoside is rebaudioside A, rebaudioside D, stevioside, rebaudioside M, or any combinations thereof.

In particular embodiments, the steviol glycoside in the beverage is rebaudioside A. In other embodiments, the steviol glycoside in the beverage is rebaudioside D. In other embodiments, the steviol glycoside in the beverage is rebaudioside M. In other embodiments, the steviol glycoside in the beverage is rebaudioside F. In other embodiments, the steviol glycoside in the beverage is a mixture of rebaudiosides A and D. In other embodiments, the steviol glycoside in the beverage is a mixture of rebaudiosides A and M. In still further embodiments, the steviol glycoside in the beverage is a mixture of rebaudiosides A, D, and M. In still further embodiments, the steviol glycoside in the beverage is a mixture of stevioside, rebaudioside A, and rebaudioside D. In other embodiments, the steviol glycoside in the beverage is a mixture of stevioside, rebaudioside A, and rebaudioside M. In yet another embodiment, the steviol glycoside is a mixture of rebaudiosides D, M, and stevioside.

In certain embodiments, the non-nutritive sweetener can be present in the beverage in a concentration ranging from about 1 ppm to about 800 ppm, from about 1 ppm to about 750 ppm, from about 1 ppm to about 700 ppm, from about 1 ppm to about 650 ppm, from about 1 ppm to about 600 ppm, from about 1 ppm to about 550 ppm, from about 1 ppm to about 500 ppm, from about 1 ppm to about 450 ppm, from about 1 ppm to about 400 ppm, from about 1 ppm to about 350 ppm, from about 1 ppm to about 300 ppm, from about 1 ppm to about 250 ppm, from about 1 ppm to about 200 ppm, from about 1 ppm to about 150 ppm, from about 1 ppm to about 100 ppm, from about 1 ppm to about 50 ppm, from about 1 ppm to about 10 ppm, or from about 1 ppm to about 5 ppm depending upon the particular non-nutritive sweetener(s) being used and the desired level of sweetness in the beverage. In particular embodiments, the non-nutritive sweetener can be present in the beverage in a concentration of about 1 ppm, about 5 ppm, about 10 ppm, about 50 ppm, about 100 ppm, about 150 ppm, about 200 ppm, about 250 ppm, about 300 ppm, about 350 ppm, about 400 ppm, about 450 ppm, about 500 ppm, about 550 ppm, about 600 ppm, about 650 ppm, about 700 ppm, about 750 ppm, or about 800 ppm.

In certain embodiments the beverage comprises rebaudioside A, rebaudioside D, and rebaudioside M, wherein rebaudioside A and rebaudioside D are present in a weight ratio in a range of from about 2.2:1 to about 1.8:1, wherein rebaudioside A and rebaudioside M are present in a weight ratio in a range of from about 2.2:1 to about 1.8:1.

In certain embodiments, the weight ratio of rebaudioside A to rebaudioside D in the beverage is in a range of from about 2.1:1 to about 1.9:1. In certain embodiments, the weight ratio of rebaudioside A to rebaudioside D is about 2:1.

In certain embodiments, the weight ratio of rebaudioside A to rebaudioside M in the beverage is in a range of from about 2.1:1 to about 1.9:1. In certain embodiments, the weight ratio of rebaudioside A to rebaudioside M is about 2:1.

In certain embodiments, rebaudioside A is present in a concentration of from about 50 ppm to about 300 ppm in the beverage.

In certain embodiments, rebaudioside D is present in a concentration of from about 50 ppm to about 300 ppm in the beverage.

In certain embodiments, rebaudioside M is present in a concentration of from about 50 ppm to about 300 ppm in the beverage.

The beverage composition of the present disclosure can further comprise a nutritive sweetener. In some embodiments, the nutritive sweetener can be a natural nutritive sweetener. Exemplary natural nutritive sweeteners that can be included in the composition include any of those known in the art, for example, crystalline or liquid sucrose, fructose, glucose, fructo-oligosaccharides, glucose-fructose syrup from natural sources such as apple, chicory, and honey; high fructose corn syrup, invert sugar, maple syrup, maple sugar, honey, brown sugar molasses, cane molasses, such as first molasses, second molasses, blackstrap molasses, and sugar beet molasses; sorghum syrup, and mixtures thereof.

Other ingredients suitable for use in the beverage composition disclosed herein include, but are not limited to, sugar alcohols (erythritol, sorbitol, mannitol, xylitol, lactitol, isomalt, malitol), tagatose, trehalose, galactose, rhamnose, cyclodextrin, ribulose, threose, arabinose, xylose, lyxose, allose, altrose, mannose, idose, lactose, maltose, isotrehalose, neotrehalose, palatinose or isomaltulose, erythrose, deoxyribose, gulose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, iso-maltoligosaccharides, malto-oligosaccharides (maltotriose, maltotetraose, maltopentaose, maltohexaose, maltoheptaose and the like), dextrins, lactulose, melibiose, raffinose, rhamnose, ribose, and mixtures thereof.

In certain embodiments the nutritive sweetener can be sucrose, high-fructose corn syrup, or a combination thereof.

The beverage composition can also include one or more rare sugars, such as D-allose, D-psicose (also known as D-allulose), L-ribose, D-tagatose, L-glucose, L-fucose, L-arabinose, D-turanose, D-leucrose, and mixtures thereof. In particular embodiments, the composition can comprise D-psicose.

The beverage composition of the present disclosure can also contain an artificial sweetener or a sweetness enhancer.

Exemplary artificial sweeteners include, but are not limited to, saccharin, cyclamate, aspartame, neotame, advantame, acesulfame potassium, sucralose, and mixtures thereof.

In some embodiments the beverage composition can further comprise a sweetness enhancer. Suitable sweetness enhancers include any of those known in the art. Exemplary sweetness enhancers include, but are not limited to sugar alcohol sweetness enhancer (such as erythritol, sorbitol, mannitol, xylitol, lactitol, isomalt, malitol, and mixtures thereof), or rare sugar sweetness enhancer (D-psicose, D-allose, L ribose, D-tagatose, L glucose, L-fucose, L-arabinose, D-turanose, D-leucrose, and mixtures thereof). In certain embodiments, any of the steviol glycosides described herein can function as a sweetness enhancer, rather than as a sweetener. In particular embodiments, the sweetness enhancer can be rebaudioside A. In particular embodiments, the sweetness enhancer can be rebaudioside B. In particular embodiments, the sweetness enhancer can be rebaudioside C. In particular embodiments, the sweetness enhancer can be rebaudioside D. In particular embodiments, the sweetness enhancer can be rebaudioside E. In particular embodiments, the sweetness enhancer can be rebaudioside F. In particular embodiments, the sweetness enhancer can be rebaudioside J. In particular embodiments, the sweetness enhancer can be rebaudioside K. In particular embodiments, the sweetness enhancer can be rebaudioside L. In particular embodiments, the sweetness enhancer can be rebaudioside M. In particular embodiments, the sweetness enhancer can be rebaudioside N. In particular embodiments, the sweetness enhancer can be rebaudioside O.

In certain embodiments when the sweetness enhancer is a rebaudioside the rebaudioside is present in the beverage product at a concentration of between about 1 ppm and about 50 ppm. In some embodiments the rebaudioside is present in the beverage product at a concentration of between about 5 ppm and about 40 ppm, about 10 ppm and about 30 ppm, or about 15 ppm and about 20 ppm.

In some embodiments, the sweetness enhancer can be a salt based sweetness enhancer (such as NaCl or potassium sorbate) or a benzoic acid based sweetness enhancer (such as potassium benzoate).

In some embodiments, the beverage composition can further comprise caffeine. In other embodiments, the beverage composition can be substantially caffeine free, or is caffeine free.

In certain embodiments, the beverage composition can further comprise other ingredients such as antioxidants, food grade acids, and food grade bases. Other beverage components such as colors, preservatives, carbon dioxide, buffering salts, and the like, can also be present.

Suitable food grade acids are water soluble organic acids and their salts and include, for example, phosphoric acid, sorbic acid, ascorbic acid, benzoic acid, citric acid, tartaric acid, propionic acid, butyric acid, acetic acid, succinic acid, glutaric acid, maleic acid, malic acid, valeric acid, caproic acid, malonic acid, aconitic acid, potassium sorbate, sodium benzoate, sodium citrate, amino acids, and combinations of any of them. Such acids are suitable for adjusting the pH of the food or beverage.

Suitable food grade bases are sodium hydroxide, potassium hydroxide, and calcium hydroxide. Such bases also are suitable for adjusting the pH of a food or beverage.

In certain embodiments, the beverage composition can further comprise one or more stabilizers selected from the group consisting of comprise pectin, xanthan gum, carboxymethylcellulose, propylene glyclol alginate, gellan gum, guar gum, tragacanth gum, gum acacia, locust bean gum, gum arabic, gelatin, and combinations thereof. These compounds can also function as emulsifiers for stabilizing, for example, clouding agents.

In some embodiments, the beverage can be a cola beverage. In other embodiments, the cola beverage can comprise cola flavoring and a non-nutritive sweetener selected from the group consisting of a steviol glycoside, Lo Han Guo sweetener, rubusoside, siamenoside, monatin, curculin, glycyrrhizic acid, neohesperidin, dihydrochalcone, glycyrrhizin, glycyphyllin, phloridzin, trilobatin, phyllodulcin, brazzein, hernandulcin, osladin, polypodoside A, baiyunoside, pterocaryoside A and B, mukurozioside, thaumatin, monellin, mabinlins I and II, phlomisoside I, periandrin I, abrusoside A, and cyclocarioside I, mogroside IV, mogroside V, or combinations thereof.

In particular embodiments, the beverage can be a carbonated cola beverage, containing, among other things, water, sweetener, kola nut extract and/or other flavorings, caramel coloring, phosphoric acid, optionally caffeine, and optionally other ingredients. Additional and alternative suitable ingredients will be recognized by those skilled in the art given the benefit of this disclosure.

Carbonation in the form of carbon dioxide can be added for effervescence. Any of the techniques and carbonating equipment known in the art for carbonating beverages can be employed. Carbon dioxide can enhance beverage taste and appearance and can aid in safeguarding the beverage purity by inhibiting and/or destroying objectionable bacteria. In certain embodiments, for example, the beverage can have a CO₂ level up to about 4.0 volumes carbon dioxide. Other embodiments can have, for example, from about 0.5 to about 5.0 volumes of carbon dioxide. As used herein, one volume of carbon dioxide refers to the amount of carbon dioxide absorbed by a given quantity of a given liquid, such as water, at 60° F. (16° C.) and one atmospheric pressure. A volume of gas occupies the same space as does the liquid by which it is dissolved. The carbon dioxide content can be selected by those skilled in the art based on the desired level of effervescence and the impact of the carbon dioxide on the taste or mouthfeel of the beverage.

Beverages can have any of numerous different specific formulations or constituents. The formulation of a beverage can vary, depending upon such factors as the product's intended market segment, its desired nutritional characteristics, flavor profile, and the like. Thus further ingredients can be added to the formulation of a particular beverage. Further ingredients include, but are not limited to, one or more additional sweeteners in addition to any sweetener already present, electrolytes, vitamins, flavor enhancers, carbonation, preservatives, or any combination thereof. These ingredients can be added to any of the beverage compositions to vary the taste, mouthfeel, and/or nutritional values of the beverage composition.

In certain embodiments, the food or beverage compositions disclosed herein can contain a flavor composition, for example, natural, nature identical, and/or synthetic fruit flavors, botanical flavors, other flavors, and combinations thereof. As used herein, the term “fruit flavor” refers generally to those flavors derived from the edible reproductive part of a seed plant including those plants wherein a sweet pulp is associated with the seed, e.g., tomato, cranberry, and the like, and those having a small, fleshy berry. The term berry includes true berries as well as aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime grapefruit, tangerine, mandarin orange, tangelo, and pomelo, apple, grape, cherry, and pineapple flavors. In certain embodiments, the food or beverage compositions comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots, and leaves. Also included within the term “botanical flavor” are synthetically prepared flavors made to simulate botanical flavors derived from natural sources. Examples of such flavors include cola flavors, tea flavors, and combinations thereof. The flavor component may further comprise a blend of several of the above-mentioned flavors. In certain exemplary embodiments of the food or beverage compositions, a cola flavor component can be used or a tea flavor component. The particular amount of the flavor component useful for imparting flavor characteristics to the food or beverage compositions of the present disclosure will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in certain exemplary embodiments of the beverage disclosed herein include, e.g., fruit, vegetable and berry juices. Juices may be employed in the food or beverage compositions in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a concentrate or beverage having a desired flavor. Examples of suitable juice sources include plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin, melon, watermelon, and grapefruit. Numerous additional and alternative juices suitable for use in at least certain exemplary embodiments will be apparent to those skilled in the art given the benefit of this disclosure. In the compositions of the present disclosure employing juice, juice can be used, for example, at a level of at least about 0.2 weight percent of the composition. In certain embodiments juice can be employed at a level ranging from about 0.2 weight percent to about 40 weight percent. In further embodiments, juice can be used, if at all, in an amounts ranging from about 1 weight percent to about 20 weight percent.

Juices that are lighter in color can be included in the formulation of certain embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the food or beverage compositions disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings may be in the form of an extract, oleoresin, juice concentrate, bottler's base, or other forms known in the art. In at least certain exemplary embodiments, such spice or other flavors complement that of a juice or juice combination.

The one or more flavorings may be used in the form of an emulsion. A flavoring emulsion can be prepared by mixing some or all of the flavorings together, optionally together with other ingredients of the food or beverage, and an emulsifying agent. The emulsifying agent can be added with or after the flavorings mixed together. In certain exemplary embodiments the emulsifying agent can be water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of food or beverage formulations, given the benefit of this disclosure. The emulsifier in exemplary embodiments comprises greater than about 3% of the mixture of flavorings and emulsifier. In certain exemplary embodiments the emulsifier can be from about 5% to about 30% of the mixture.

In certain embodiments, caffeine can be added to any of the food or beverage compositions described herein. For example, the amount of caffeine added can be determined by the desired properties of a given beverage or beverage concentrate, and any applicable regulatory provisions of the country where the beverage or beverage concentrate is marketed. In certain embodiments caffeine can be included in an amount sufficient to provide a final beverage composition having less than about 0.02 weight percent caffeine. The caffeine must be of purity acceptable for use in beverage food or beverage. The caffeine may be natural or synthetic in origin.

The beverage disclosed here can contain additional ingredients, including, generally, any of those typically found in beverage formulations. Examples of such additional ingredients include, but are not limited to, caramel and other coloring agents or dyes, foaming or antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. The optional non-mineral nutritional supplements are typically present in amounts generally accepted under good manufacturing practices. Exemplary amounts can be between about 1% and about 100% Recommended Daily Value (RDV), where such RDVs are established. In certain exemplary embodiments the non-mineral nutritional supplement ingredient(s) can be present in an amount ranging from about 5% to about 20% RDV, where established.

Preservatives may be used in at least certain embodiments of the food or beverage compositions disclosed here. That is, at least certain exemplary embodiments can contain an optional dissolved preservative system. Solutions with a pH below 4 and especially those below 3 typically are “micro-stable,” i.e., they resist growth of microorganisms, and so are suitable for longer term storage prior to consumption without the need for further preservatives. However, an additional preservative system can be used if desired. If a preservative system is used, it can be added to the product at any suitable time during production, e.g., in some cases prior to the addition of sweeteners. As used here, the terms “preservation system” or “preservatives” include all suitable preservatives approved for use in food or beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and combinations thereof, and antioxidants such as ascorbic acid, EDTA, BHA, BHT, TBHQ, dehydroacetic acid, dimethyldicarbonate, ethoxyquin, heptylparaben, and combinations thereof. Preservatives may be used in amounts not exceeding mandated maximum levels under applicable laws and regulations.

In the case of beverages in particular, the level of preservative used can be adjusted according to the planned final product pH and/or the microbiological spoilage potential of the particular beverage formulation. The maximum level employed typically can be about 0.05 weight percent of the beverage. It will be within the ability of those skilled in the art, given the benefit of this disclosure, to select a suitable preservative or combination of preservatives for beverage compositions according to this disclosure.

Other methods of preservation suitable for at least certain exemplary embodiments of the products disclosed here include, e.g., aseptic packaging and/or heat treatment or thermal processing steps, such as hot filling and tunnel pasteurization. Such steps can be used to reduce yeast, mold and microbial growth in the food or beverage compositions. For example, U.S. Pat. No. 4,830,862 discloses the use of pasteurization in the production of fruit juice beverages as well as the use of suitable preservatives in carbonated beverages. U.S. Pat. No. 4,925,686 discloses a heat-pasteurized freezable fruit juice composition which contains sodium benzoate and potassium sorbate. Both of these patents are incorporated by reference in their entireties. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

Suitable antioxidants may be selected from the group consisting of rutin, quercetin, flavonones, flavones, dihydroflavonols, flavonols, flavandiols, leucoanthocyanidins, flavonol glycosides, flavonone glycosides, isoflavonoids, and neoflavonoids. In particular, the flavonoids may be, but not limited to, quercetin, eriocitrin, neoeriocitrin, narirutin, naringin, hesperidin, hesperetin, neohesperidin, neoponcirin, poncirin, rutin, isorhoifolin, rhoifolin, diosmin, neodiosmin, sinensetin, nobiletin, tangeritin, catechin, catechin gallate, epigallocatechin, epigallocatechin gallate, oolong tea polymerized polyphenol, anthocyanin, heptamethoxyflavone, daidzin, daidzein, biochaminn A, prunetin, genistin, glycitein, glycitin, genistein, 6,7,4′-trihydroxy isoflavone, morin, apigenin, vitexin, balcalein, apiin, cupressuflavone, datiscetin, diosmetin, fisetin, galangin, gossypetin, geraldol, hinokiflavone, primuletin, pratol, luteolin, myricetin, orientin, robinetin, quercetagetin, and hydroxy-4-flavone.

Suitable food grade acids are water soluble organic acids and their salts and include, for example, phosphoric acid, sorbic acid, ascorbic acid, benzoic acid, citric acid, tartaric acid, propionic acid, butyric acid, acetic acid, succinic acid, glutaric acid, maleic acid, malic acid, valeric acid, caproic acid, malonic acid, aconitic acid, potassium sorbate, sodium benzoate, sodium citrate, amino acids, and combinations of any of them. Such acids are suitable for adjusting the pH of the food or beverage.

Suitable food grade bases are sodium hydroxide, potassium hydroxide, and calcium hydroxide. Such bases also are suitable for adjusting the pH of a food or beverage.

In certain embodiments, the beverage in accordance with this disclosure can comprise water, a dairy mineral composition, at least one sweetener, an acidulant, and a flavoring. Exemplary flavorings include, but are not limited to, cola flavoring, citrus flavoring, spice flavorings, and combinations thereof. Carbonation in the form of carbon dioxide can be added for effervescence. In certain embodiments, preservatives can be added if desired or necessary, depending upon factors including the presence of other ingredients, production technique, desired shelf life, etc. In certain embodiments, caffeine can be added to the beverage. Other suitable ingredients are described herein.

Additional and alternative suitable ingredients will be recognized by those skilled in the art given the benefit of this disclosure.

### Beverage Concentrates

The present disclosure also provides a beverage concentrate comprising the dairy mineral composition.

Beverage concentrates are well known to those of ordinary skill in the art and are typically a liquid concentrate suitable for dilution with water to provide a ready to drink beverage. Typically, concentrates are prepared at concentrations 3 to 10 times the concentration of the finished ready to drink beverage. In some embodiments, the concentrate can be six times more concentrated than the desired finished beverage product.

When the concentrate is six times more concentrated than a final beverage concentration, the concentrate can be diluted with water or carbonated water in a 1-plus-5-throw (1 volume of beverage concentrate plus 5 volumes of water). In an embodiment where the concentrate is six times more concentrated than the beverages, the dairy mineral composition can be present in the beverage concentrate at a concentration ranging from about 600 ppm to about 12,000 ppm. In certain embodiments the dairy mineral composition can be present in the beverage concentrate at a concentration ranging from about 700 ppm to about 11,500 ppm, from about 800 ppm to about 11,000 ppm, from about 900 ppm to about 10,500 ppm, from about 1,000 ppm to about 10,000 ppm, from about 1,100 ppm to about 9,500, from about 1,200 ppm to about 9,000 ppm, from about 1,300 ppm to about 8,500 ppm, from about 1,500 ppm to about 8,000 ppm, from about 1,600 ppm to about 7,500 ppm, from about 1,700 ppm to about 7,000 ppm, from about 1,800 ppm to about 6,500 ppm, from about 2,000 ppm to about 6,000 ppm, from about 2,500 ppm to about 5,500 ppm, from about 3,000 ppm to about 5,000 ppm, or from about 3,500 ppm to about 4,500 ppm.

In certain embodiments the dairy mineral composition can be present in the beverage concentrate at a concentration ranging from about 700 ppm to about 12,000 ppm, from about 800 ppm to about 12,000 ppm, from about 900 ppm to about 12,000 ppm, from about 1,000 ppm to about 12,000 ppm, from about 1,100 ppm to about 12,000, from about 1,200 ppm to about 12,000 ppm, from about 1,300 ppm to about 12,000 ppm, from about 1,500 ppm to about 12,000 ppm, from about 1,600 ppm to about 12,000 ppm, from about 1,700 ppm to about 12,000 ppm, from about 1,800 ppm to about 12,000 ppm, from about 2,000 ppm to about 12,000 ppm, from about 2,500 ppm to about 12,000 ppm, from about 3,000 ppm to about 12,000 ppm, from about 3,500 ppm to about 12,000 ppm, from about 4,000 ppm to about 12,000 ppm, from about 4,500 ppm to about 12,000 ppm, from about 5,000 ppm to about 12,000 ppm, from about 5,500 ppm to about 12,000 ppm, from about 6,000 ppm to about 12,000 ppm, from about 6,500 ppm to about 12,000 ppm, from about 7,000 ppm to about 12,000 ppm, from about 7,500 ppm to about 12,000 ppm, from about 8,0000 ppm to about 12,000 ppm, from about 8,500 ppm to about 12,000 ppm, from about 9,000 ppm to about 12,000 ppm, from about 9,500 ppm to about 12,000 ppm, from about 10,000 ppm to about 12,000 ppm, or from about 11,500 ppm to about 12,000 ppm.

In some embodiments that dairy mineral composition can be present in the beverage concentrate at a concentration ranging from about 600 ppm to about 11,500 ppm, from about 600 ppm to about 11,000 ppm, from about 600 ppm to about 10,500 ppm, from about 600 ppm to about 10,000 ppm, from about 600 ppm to about 9,500 ppm, from about 600 ppm to about 9,000 ppm, from about 600 ppm to about 8,500 ppm, from about 600 ppm to about 8,000 ppm, from about 600 ppm to about 7,500 ppm, from about 600 ppm to about 7,000 ppm, from about 600 ppm to about 6,500 ppm, from about 600 ppm to about 6,000 ppm, from about 600 ppm to about 5,500 ppm, from about 600 ppm to about 5,000 ppm, from about 600 ppm to about 4,500 ppm, from about 600 ppm to about 4,000 ppm, or from about 600 ppm to about 3,500 ppm.

In other embodiments the dairy mineral composition can be present in a beverage concentrate at a concentration of about 600 ppm, about 700 ppm, about 800 ppm, about 900 ppm, about 1,000 ppm, about 1,200 ppm, about 1,300 ppm, about 1,400 ppm, about 1,500 ppm, about 1,600 ppm, about 1,700 ppm, about 1,800 ppm, about 1,900 ppm, about 2,000 ppm, about 2,500 ppm, about 3,000 ppm, 3,500 ppm, 4,000 ppm, 4,500 ppm, 5,000 ppm, 5,500 ppm, 6,000 ppm, 6,500 ppm, 7,000 ppm, 7,500 ppm, 8.00 ppm, 8,500 ppm, 9,000 ppm, 9,500 ppm, about 10,000 ppm, about 11,000 ppm, about 12,000 ppm or any ranges between any of these values.

In addition to dairy mineral composition in the varying amounts described above, the beverage concentrate can also comprise a nutritive or non-nutritive natural or synthetic sweetener, or a combination of such sweeteners. Exemplary sweeteners are as disclosed above.

In some embodiments, such as when the composition is a beverage concentrate, the concentration of sweetener in the concentrate will be at least six times the concentration of the desired concentration of the sweetener in a ready-to-drink beverage.

The foregoing notwithstanding, it is within the skill of the ordinarily skilled artisan to select an appropriate sweetener concentration for the composition depending on the composition's intended use as well as the properties of the particular sweetener.

### Methods of Preparing Compositions

In another embodiment, the present disclosure provides a method for preparing compositions comprising a dairy mineral composition.

In some embodiments, the method for preparing compositions comprising a dairy mineral composition comprises adding the dairy mineral composition in an amount sufficient to achieve a final concentration in the beverage of about 100 ppm to about 2000 ppm. In some embodiments, the method for preparing compositions comprising a dairy mineral composition comprises adding the dairy mineral composition in an amount sufficient to achieve a final concentration in the beverage of about 500 ppm to about 1500 ppm. In some embodiments, the method for preparing compositions comprising a dairy mineral composition comprises adding the dairy mineral composition in an amount sufficient to achieve a final concentration in the beverage of about 150 to about 1950, from about 200 to about 1900, from about 250 to about 1850, from about 300 to about 1800, from about 350 to about 1750, from about 400 to about 1700, from about 450 to about 1650, from about 500 to about 1600, 550 ppm to about 1550 ppm, from about 600 ppm to about 1450 ppm, from about 650 ppm to about 1400 ppm, from about 700 ppm to about 1350 ppm, from about 750 ppm to about 1300 ppm, or from about 800 ppm to about 1250, from about 850 to about 1200, from about 850 ppm to about 1150 ppm, from about 900 ppm to about 1100 ppm, or from about 950 to about 1050

In some embodiments, the method for preparing compositions comprising a dairy mineral composition comprises adding the dairy mineral composition in an amount sufficient to achieve a final concentration in the beverage of from about 200 ppm to about 2000 ppm, from about 300 ppm to about 2000 ppm, from about 400 ppm to about 2000 ppm, from about 500 ppm to about 2000 ppm, from about 600 ppm to about 2000 ppm, from about 700 ppm to about 2000 ppm, from about 800 ppm to about 2000 ppm, from about 900 ppm to about 2000 ppm, from about 1000 ppm to about 2000 ppm, from about 1100 ppm to about 2000 ppm, from about 1200 ppm to about 2000 ppm, from about 1300 ppm to about 2000 ppm, from about 1400 ppm to about 2000 ppm, from about 1500 ppm to about 2000 ppm, from about 1600 ppm to about 2000 ppm, from about 1700 ppm to about 2000 ppm, from about 1800 ppm to about 2000 ppm, or from about 1900 ppm to about 2000 ppm.

In some embodiments, the method of preparing compositions comprising a dairy mineral composition comprises adding the dairy mineral composition in an amount sufficient to achieve a final concentration in the beverage of 100 ppm to about 1900, from about 100 ppm to about 1800 ppm, from about 100 ppm to about 1700 ppm, from about 100 ppm to about 1600 ppm, from about 100 ppm to about 1500 ppm, from about, 100 ppm to about 1400 ppm, from about 100 ppm to about 1300 ppm, from about 100 ppm to about 1200 ppm, from about 100 ppm to about 1100 ppm, from about 100 ppm to about 1000 ppm, from about 100 ppm to about 900 ppm, from about 100 ppm to about 800 ppm, from about 100 ppm to about 700 ppm, from about 100 ppm to about 600 ppm, or from about 100 ppm to about 500 ppm.

In some embodiments, the method of preparing compositions comprising a dairy mineral composition comprises adding the dairy mineral composition in an amount sufficient to achieve a final concentration in the beverage of 100 ppm, 150 ppm, 200 ppm, 250 ppm, 300 ppm, 350 ppm, 400 ppm, 450 ppm, 500 ppm, about 550 ppm, about 600 ppm, about 650 ppm, about 700 ppm, about 750 ppm, about 800 ppm, about 850 ppm, about 900 ppm, about 950 ppm, about 1000 ppm, about 1050 ppm, about 1100 ppm, about 1150 ppm, about 1200 ppm, about 1250 ppm, about 1300 ppm, about 1350 ppm, about 1400 ppm, about 1450 ppm, about 1500 ppm, about 1550 ppm, about 1600 ppm, about 1650 ppm, about 1700 ppm, about 1750 ppm, about 1800 ppm, about 1850 ppm, about 1900 ppm or any ranges between any of these values.

### Methods of Modifying Flavor Attributes

In another embodiment, the present disclosure provides a method for modifying flavor attributes relative to a control wherein modification of the flavor attribute is assessed by an appropriately sized taste panel of comprising trained expert tasters. Such panels are well known in the art. The method comprises adding an effective amount of the dairy mineral composition described herein to a beverage or other comestible in order to affect the beverage's organoleptic properties. In some embodiments, the method comprises enhancing a flavor attribute relative to a control. In some embodiments the method of modifying a flavor attribute comprises reducing a flavor attribute relative to a control.

In some embodiments, the method for modifying a flavor attribute of a beverage comprises adding the dairy mineral composition to the beverage in an amount sufficient to achieve a final concentration in the beverage of about 100 ppm to about 2000 ppm. In some embodiments, the method for modifying a flavor attribute of a beverage comprises adding the dairy mineral composition to the beverage in an amount sufficient to achieve a final concentration in the beverage of about 500 ppm to about 1500 ppm. In some embodiments, the method for modifying a flavor attribute of a beverage comprises adding the dairy mineral composition to the beverage in an amount sufficient to achieve a final concentration in the beverage of about 100 ppm to about 1900, from about 100 ppm to about 1800 ppm, from about 100 ppm to about 1700 ppm, from about 100 ppm to about 1600 ppm, from about 100 ppm to about 1500 ppm, from about, 100 ppm to about 1400 ppm, from about 100 ppm to about 1300 ppm, from about 100 ppm to about 1200 ppm, from about 100 ppm to about 1100 ppm, from about 100 ppm to about 1000 ppm, from about 100 ppm to about 900 ppm, from about 100 ppm to about 800 ppm, from about 100 ppm to about 700 ppm, from about 100 ppm to about 600 ppm, or from about 100 ppm to about 500 ppm.

In some embodiments, the method for modifying a flavor attribute of a beverage comprises adding a dairy mineral composition to the beverage in an amount sufficient to achieve a final concentration in the beverage of about from about 200 ppm to about 2000 ppm, from about 300 ppm to about 2000 ppm, from about 400 ppm to about 2000 ppm, from about 500 ppm to about 2000 ppm, from about 600 ppm to about 2000 ppm, from about 700 ppm to about 2000 ppm, from about 800 ppm to about 2000 ppm, from about 900 ppm to about 2000 ppm, from about 1000 ppm to about 2000 ppm, from about 1100 ppm to about 2000 ppm, from about 1200 ppm to about 2000 ppm, from about 1300 ppm to about 2000 ppm, from about 1400 ppm to about 2000 ppm, from about 1500 ppm to about 2000 ppm, from about 1600 ppm to about 2000 ppm, from about 1700 ppm to about 2000 ppm, from about 1800 ppm to about 2000 ppm, or from about 1900 ppm to about 2000 ppm.

In some embodiments, the method for modifying a flavor attribute of a beverage comprises adding a dairy mineral composition to the beverage in an amount sufficient to achieve a final concentration in the beverage of about 150 to about 1950, from about 200 to about 1900, from about 250 to about 1850, from about 300 to about 1800, from about 350 to about 1750, from about 400 to about 1700, from about 450 to about 1650, from about 500 to about 1600, 550 ppm to about 1550 ppm, from about 600 ppm to about 1450 ppm, from about 650 ppm to about 1400 ppm, from about 700 ppm to about 1350 ppm, from about 750 ppm to about 1300 ppm, or from about 800 ppm to about 1250, from about 850 to about 1200, from about 850 ppm to about 1150 ppm, from about 900 ppm to about 1100 ppm, or from about 950 to about 1050.

In some embodiments, the method for modifying a flavor attribute of a beverage comprises adding a dairy mineral composition to the beverage in an amount sufficient to achieve a final concentration in the beverage of about 100 ppm, 150 ppm, 200 ppm, 250 ppm, 300 ppm, 350 ppm, 400 ppm, 450 ppm, 500 ppm, about 550 ppm, about 600 ppm, about 650 ppm, about 700 ppm, about 750 ppm, about 800 ppm, about 850 ppm, about 900 ppm, about 950 ppm, about 1000 ppm, about 1050 ppm, about 1100 ppm, about 1150 ppm, about 1200 ppm, about 1250 ppm, about 1300 ppm, about 1350 ppm, about 1400 ppm, about 1450 ppm, about 1500 ppm, about 1550 ppm, about 1600 ppm, about 1650 ppm, about 1700 ppm, about 1750 ppm, about 1800 ppm, about 1850 ppm, about 1900 ppm or any ranges between any of these values.

In some embodiments, the method for modifying a flavor attribute of a beverage comprises adding one or more ingredients chosen from the group consisting of fat, fatty acids, carbohydrates, fiber, sucrose, glucose, maltose, lactose, galactose, isomaltose, protein, calcium, copper, iron, magnesium, manganese, phosphorus, potassium, sodium, zinc, sulfite, amino acids, ash, citric acid, lactic acid, acetic acid, oxalic acid, and formic acid.

Exemplary flavor attributes include but are not limited to overall aroma, carbonation mouthfeel, foamy mouthfeel, astringency, syrupy mouthfeel, mouthcoat, numbing mouthfeel, irritation, sweetness, bitterness, sourness, metallic taste, metallic mouthfeel, or metallic smell, overall flavor, lime smell, lemon-candy smell, grapefruit taste, fresh orange taste, baby aspirin smell, artificial aftertaste, sugary smell, honey smell, mustiness, throat catch, tropical smell, pledge smell, ginger/woody smell, slippery/slimy mouthfeel, dried fruit smell, dried fruit taste, licorice smell, piney-citrus smell, clove smell, cooling taste, chalky taste, chalky mouthfeel, and chalky smell. In some embodiments the flavor attribute is measured after 60 seconds.

In some embodiments the method for modifying a flavor attribute is a method of enhancing mouthfeel. In some embodiments the method for modifying a flavor attribute is a method of enhancing mouthcoat. In some embodiments the method for modifying a flavor attribute is a method of enhancing sweetness. In some embodiments the method for modifying a flavor attribute is enhancing sugary smell. In some embodiments the method of modifying mouthfeel is a method of enhancing honey smell.

In some embodiments the method for modifying a flavor attribute is a method of reducing astringency. In some embodiments the method for modifying a flavor attribute is a method of reducing numbing mouthfeel. In some embodiments the method for modifying a flavor attribute is a method of reducing irritation. In some embodiments the method for modifying a flavor attribute is a method of reducing sour taste. In some embodiments the method for modifying a flavor attribute is a method of reducing artificial aftertaste. In some embodiments the method for modifying a flavor attribute is a method of reducing throat catch. In some embodiments the method for modifying a flavor attribute is a method of masking bitterness. In some embodiments the method for modifying a flavor attribute is a method of increasing syrupy mouthfeel.

### EMBODIMENTS

In addition to the various embodiments described above, the present disclosure includes the following specific embodiments number E1 through E25. This list of embodiments is presented as an exemplary list and the application is not limited to these embodiments.

E1. A dairy mineral composition comprising from about 2% to about 20% by weight carbohydrates, and from about 6% to about 20% by weight protein.

E2. The dairy mineral composition of E1, further comprising from about 55% to about 95% ash and from about 2% to about 8% by weight moisture.

E3. The dairy mineral composition of E2, comprising about 3.5% by weight carbohydrates, about 8% by weight protein, about 80% by weight ash, and about 4.5% by weight moisture.

E4. The dairy mineral composition of E3, wherein the carbohydrate is lactose.

E5. The dairy mineral composition of E2, comprising about 15% by weight carbohydrates, about 15% by weight protein, about 65% by weight ash, about 3% by weight moisture, and further comprising about 0.4% by weight fat.

E6. The dairy mineral composition of E5, wherein the carbohydrate is lactose.

E7. A dairy mineral composition comprising about 5% by weight lactose, and about 8% by weight protein.

E8. A dairy mineral composition comprising about 0.4% by weight fat, about 16% by weight lactose, and about 15% by weight protein.

E9. A dairy mineral composition comprising at least about 8% by weight protein, at least 10% by weight potassium, and at least about 3% by weight sodium.

E10. The dairy mineral composition of E9 further comprising no more than 4% by weight moisture, no more than 15% by weight calcium, and no more than 5% by weight phosphorus.

E11. A dairy mineral composition comprising no more than 15% by weight calcium and no more than 5% by weight phosphorus.

E12. A dairy mineral composition comprising from about 0.1% to about 5% by weight calcium, about 0.1% to about 5% by weight phosphorus, from about 10% to about 40% by weight potassium, and about 5% to about 15% by weight sodium.

E13. A dairy mineral composition comprising at least about 30% by weight ash and no more than 20% by weight carbohydrates.

E14. A beverage composition comprising from about 1 ppm to about 400 ppm carbohydrates, from about 2 ppm to about 400 ppm protein, and from about 0.2 ppm to about 75 ppm calcium.

E15. The beverage of E14 comprising about 35 ppm carbohydrates, and about 80 ppm protein.

E16. The beverage of E14 wherein the carbohydrate is lactose.

E17. The beverage of E14 comprising about 160 ppm carbohydrates, and about 150 ppm protein.

E18. The beverage of E16 comprising about 150 ppm lactose, about 150 ppm protein, and about 4 ppm calcium.

E19. A beverage composition comprising from about 1 ppm to about 400 ppm carbohydrates and from about 2 ppm to about 400 ppm protein.

E20. The beverage of E19 wherein the carbohydrate is lactose.

E21. The beverage of E20 comprising about 35 ppm lactose, and about 80 ppm protein.

E22. The beverage of E21 comprising about 150 ppm lactose, and about 150 ppm protein.

E23. A beverage composition, comprising a dairy mineral composition, comprising no more than 100 ppm calcium.

E24. The beverage composition of E23 comprising at least about 80 ppm protein, at least 100 ppm potassium, and at least about 30 ppm sodium.

E25. A beverage composition, comprising a dairy mineral composition, comprising at least about 80 ppm protein, at least 100 ppm potassium, and at least about 30 ppm sodium.

### EXAMPLES

### Example 1: Dairy Mineral Compositions

The compositions of four commercially available dairy minerals were compared. Sample 1 was obtained from Wimm-Bill-Dann Foods OJSC. Sample 2, Lactosalt Optitaste®, was obtained from Armor Proteines S.A.S. Sample 3, TruCal® D-7, was obtained from Glanbia, Plc. Sample 4, Reduced Lactose Whey, was obtained from Wapsie Valley Creamery, Inc.

Sample 1 was subjected to the following compositional analysis. Ash content of the dairy mineral composition was analyzed using Official Methods of Analysis of AOAC INTERNATIONAL, 18th Ed., Method 923.03, AOAC INTERNATIONAL, Gaithersburg, Md., USA, (2005). Carbohydrate content in the dairy mineral composition was analyzed using United States Department of Agriculture, “Energy Value of Foods,” Agriculture Handbook No. 74, pp. 2-11, (1973). Elemental content in the dairy mineral composition was analyzed using Official Methods of Analysis of AOAC INTERNATIONAL, 18th Ed., Method 984.27 and 985.01, AOAC INTERNATIONAL, Gaithersburg, Md., USA, (2005). Fat content was quantified using Official Methods of Analysis of AOAC INTERNATIONAL, 18th Ed., Methods 922.06 and 954.02, AOAC INTERNATIONAL, Gaithersburg, Md., USA, (2005). Moisture content in the dairy mineral composition was measured using Official Methods of Analysis of AOAC INTERNATIONAL, 18th Ed., Methods 925.09 and 926.08, AOAC INTERNATIONAL, Gaithersburg, Md., USA, (2005). Protein content in the dairy minerals was analyzed using Official Methods of Analysis of AOAC INTERNATIONAL, 18th Ed., Methods 968.06 and 992.15, AOAC INTERNATIONAL, Gaithersburg, Md., USA, (2005).

Sample 2 was subjected to the following compositional analysis. Ash content of the dairy mineral composition was analyzed using NF V04-208. Milk. Determination of ash, Association Française de Normalisation (AFNOR) (1989). Elemental content in the dairy mineral composition was analyzed using ISO 8070:2007 (IDF 119:2007) Milk and milk products—Determination of calcium, sodium, potassium and magnesium contents—Atomic absorption spectrometric method, International Organization for Standardization. Moisture content in the dairy mineral composition was measured using NF V04-348, Dry milk—Determination of moisture content—Steaming method, AFNOR (1978). Protein content in the dairy minerals was analyzed using ISO 8968-1:2014/IDF 20-1:2014.

The compositions and testing methods of samples, 2, 3, and 4 were obtained from product data sheets and are considered “typical” values for these compositions.

The compositional data is shown in Table 1.

TABLE 1
Dairy Mineral Compositions

| | Sample 1 | Sample 2 | Sample 3 | Sample 4 |
|---|---|---|---|---|
| Calories (cal/100 g) | 121 | 46 | 60 | 322 |

Overall Composition (%)

| | | | | |
|---|---|---|---|---|
| Fat | 0.4 | 0 | 0.3 | 1.89 |
| Carbohydrates | 15.2 | 3.6 | 10 | 52.47 |
| Protein | 14.8 | 8 | 7 | 23.81 |
| Ash | 66.7 | 78-86 | 78 | 17.93 |
| Moisture | 3.23 | 5.5-6 | 6 | 3.9 |
| Total | 100.33 | 100.02 | 101.3 | 100 |

Carbohydrates

| | | | | |
|---|---|---|---|---|
| Lactose | 16.2 | 3.6-7 | 6.66 | 39.54 |

Elements

| | | | | |
|---|---|---|---|---|
| Ca | 0.432 | 2.5 | 25.06 | 1.28 |
| P | 1.12 | — | 14 | — |
| K | 21.2 | 28-32 | 0.7 | 4.64 |
| Na | 8.43 | 7-10 | 0.62 | 2.18 |

### Example 2: Beverage Compositions

Lemon-lime beverage and cola beverage syrups having the ingredients shown in Tables 2 and 3 were prepared by combining the ingredients using standard preparatory techniques.

TABLE 2
Lemon Lime Beverage Syrup

| Ingredients | Target Mass (g) |
|---|---|
| Water | 800.8400 |
| sucrose granulated | 281.4500 |
| sodium benzoate | 1.4390 |
| sodium citrate trihydrate | 2.7970 |
| citric acid anhydrous | 6.2690 |
| malic acid | 3.1950 |
| acesulfame potassium | 0.3195 |
| 25% Liquid Sucralose | 0.4560 |
| Dry Sweetener Blend¹ | 0.6749 |
| Flavor | 10.3740 |

¹The Dry Sweetener Blend comprises steviol glycosides including Rebaudioside A

TABLE 3
Cola Beverage Syrup

| Ingredient | Target Mass (g) |
|---|---|
| Water | 797.3800 |
| Sucrose granulated | 293.5200 |
| K-sorbate | 0.6000 |
| citric acid anhydrous | 0.3205 |
| Acesulfame Potassium | 0.3833 |
| 25% Liq. Sucralose | 1.5330 |
| Acidulant | 14.5320 |
| Flavor | 4.6220 |

The lemon-lime and cola syrups were each individually combined with carbonated water in a 1:5 ratio (1-plus-5-throw (1 volume of beverage concentrate plus 5 volumes of carbonated water)) to make finished lemon-lime and cola beverages.

Four beverages: Beverages 1, 2, 3, and 4, were prepared by adding a sufficient quantity of the dairy mineral composition identified as Samples 1, 2, 3, or 4, respectively, from Example 1, to a portion of the finished lemon-lime beverage to achieve a concentration of the dairy mineral composition of 1000 ppm in the beverage and stirring the mixture. A lemon-lime control beverage, identical to Beverages 1, 2, 3, and 4 except for the addition of the dairy mineral composition, was also prepared. Samples 1 and 2 produced clear beverages. Samples 3 and 4 produced slightly cloudy beverages.

### Example 3: Sensory Evaluation Study

A sensory evaluation test was conducted to show that dairy mineral compositions enhance the mouthfeel of a mid-calorie lemon-lime flavored beverage. Five experts were asked to evaluate the mouthfeel properties of Beverages 1, 2, 3, and 4 and the lemon-lime control beverage in a blind taste test and to rate the beverage's mouthfeel from lowest (1) to highest (5). For purposes of this evaluation, “higher mouthfeel” meant a mouthfeel more like a beverage sweetened with sugar, and “lower mouthfeel” indicated a mouthfeel more like a beverage sweetened with only a high intensity non-nutritive sweetener. The expert tasters cleansed their palates three times with water prior to tasting. After cleansing their palates, the tasters were presented with five samples: the control sample and one of each of Beverages 1, 2, 3, and 4. All beverages were blind coded. Beverages were evaluated according to the following protocol: choose a first beverage and swirl it in the mouth for 10 seconds; spit the beverage out; wait 10 seconds; swirl the second beverage in the mouth for 10 seconds; spit it out; etc. The results are shown below in Table 4.

TABLE 4

| | | Beverage | Beverage | Beverage | Beverage |
|---|---|---|---|---|---|
| Taster | Control | 1 | 2 | 3 | 4 |
| 1 | 1 | 3 | 2 | 4 | 5 |
| 2 | 1 | 2 | 3 | 5 | 4 |
| 3 | 1 | 5 | 4 | 2 | 3 |
| 4 | 4 | 5 | 3 | 2 | 1 |
| 5 | 2 | 5 | 1 | 4 | 3 |
| Sum | 9 | 20 | 13 | 17 | 16 |

As shown in Table 4, Beverages 1, 2, 3, and 4 containing the dairy mineral compositions Samples 1, 2, 3, and 4 exhibited higher mouthfeel compared to the control beverage.

### Example 4: Flavor Attributes

### 4A. Flavor Attributes of Mid-Calorie Lemon-Lime Beverage

A flavor attribute test was conducted to show that the dairy mineral composition modifies the flavor attributes of a mid-calorie lemon-lime flavored beverage. Beverage 1 and the control lemon-lime beverage were prepared as described above. Ten trained tasters were asked to evaluate Beverage 1 against the control lemon-lime beverage. For each test sample, the tasters indicated the intensity of each sensory attribute on a 150-point scale.

Two evaluations (replicates) were obtained from each panelist for each evaluation. The samples were evaluated for the following flavor attributes: overall aroma, carbonation mouthfeel, foamy mouthfeel, astringent mouthfeel, syrupy mouthfeel, mouthcoat, numbing mouthfeel, irritating mouthfeel, sweet taste, bitter taste, sour taste, metallic taste, overall flavor, lime smell, lemon-candy smell, grapefruit taste, fresh orange taste, baby aspirin smell, artificial aftertaste, sugary smell, honey smell, musty, throat catch, tropical smell, pledge smell, ginger/woody, slippery/slimy mouthfeel, dried fruit taste, dried fruit smell, licorice smell, piney-citrus smell, clove smell, cooling taste, and chalky taste, chalky mouthfeel, or chalky smell. Each flavor attribute was also evaluated after 60 seconds. Samples were presented blind and coded with random three-digit numbers.

Each panelists took a sip, swirled the sample in his or her mouth for 10 seconds, expectorated and subsequently rated each flavor attribute immediately or after 60 seconds The scores were discussed and a final consensus was reached for each flavor attribute.

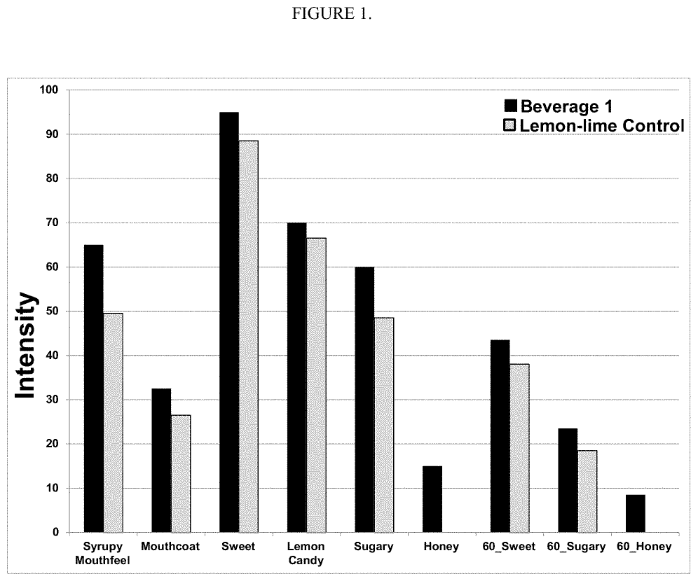

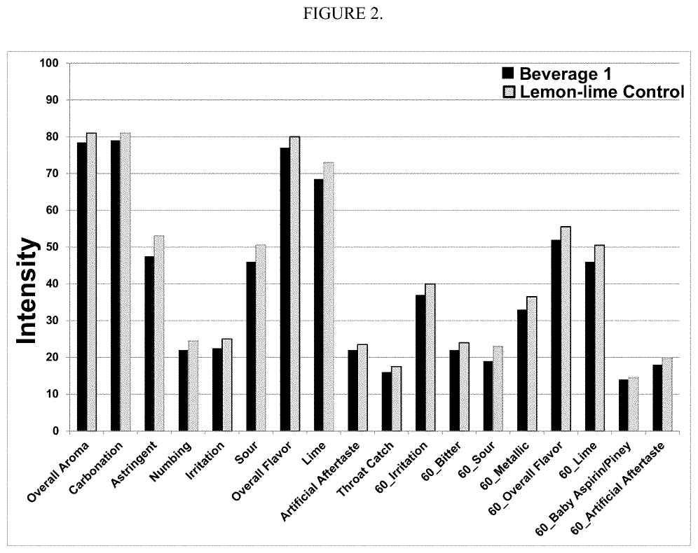

As shown in FIG. 1, Beverage 1 showed increases in syrupy mouthfeel, mouthcoat, sweet taste, lemon candy smell, sugary smell, honey smell, 60 second sweet taste, 60 second sugary smell, and 60 second honey smell compared to the lemon-lime control. As shown in FIG. 2, Beverage 1 showed a decrease in each of overall aroma, carbonation mouthfeel, astringency, numbing, irritation, sour taste, overall flavor, lime smell, artificial aftertaste, throat catch, 60 second irritation, 60 second bitter taste, 60 second sour taste, 60 second metallic taste, 60 second overall flavor, 60 second lime smell, 60 second baby aspirin/pine smell, and 60 second artificial aftertaste compared to the lemon-lime control.

### 4B. Flavor Attributes of Mid-Calorie Cola Beverage

A flavor attribute test was conducted to show that the dairy mineral composition modifies the flavor attributes of a mid-calorie cola flavored beverage. Beverage 5 was prepared by adding a sufficient quantity of Sample 1 to a portion of the finished cola beverage to achieve a concentration of 1000 ppm dairy mineral composition in the finished beverage, and stirring the mixture. A cola control beverage identical to Beverage 5 except for the addition of the dairy mineral composition, was also prepared. Ten trained tasters were asked to evaluate Beverage 5 compared against the cola control beverage. For each test sample, the panelists indicated the intensity of each sensory attribute on a 150-point scale.

Two evaluations (replicates) were obtained from each panelist for each flavor attribute. Samples were presented blind and coded with random three-digit numbers.

Each panelists took a sip, swirled the sample in his or her mouth for 10 seconds, expectorated and subsequently rated the flavor attribute using a 150-point line scale either immediately or after 60 seconds. The scores were discussed, and a final consensus was reached for each flavor attribute.

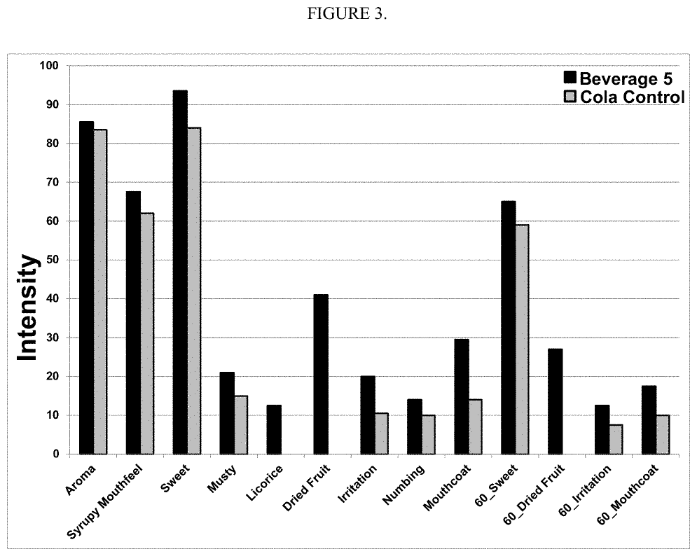

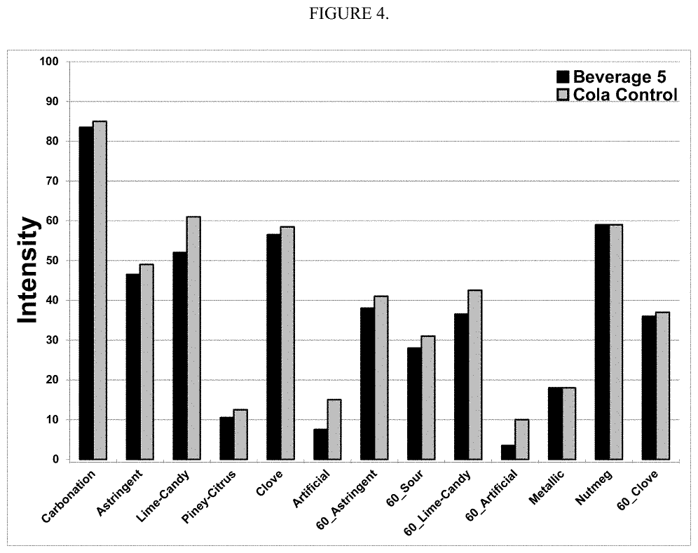

As shown in FIG. 3, Beverage 1 showed increase in aroma, syrupy mouthfeel, mouthcoat mouthfeel, sweet taste, musty off note, licorice, dried fruit taste, irritating mouthfeel, numbing mouthfeel, 60 second sweet taste, 60 second dried fruit taste, 60 second irritating mouthfeel and 60 second mouthcoat compared to cola control. As shown in FIG. 4, Beverage 5 showed a decrease in carbonation, astringent mouthfeel, lime candy smell, piney-citrus smell, clove smell, artificial aftertaste, 60 second astringent mouthfeel, 60 second sour taste, 60 second lime-candy smell, 60 second artificial aftertaste compared to the cola control.

The breadth and scope of the present invention should not be limited by any of the above-described exemplary embodiments but should be defined only in accordance with the following claims and their equivalents.

All patents, patent applications, and other reference noted or referenced in this application are hereby incorporated by reference in their entirety.

1. A beverage composition comprising a dairy mineral composition, wherein the beverage is carbonated.

2. The beverage composition of claim 1, further comprising a non-nutritive sweetener.

3. The beverage composition of claim 2, wherein the non-nutritive sweetener is selected from the group consisting of a steviol glycoside, Lo Han Guo sweetener, rubusoside, siamenoside, monatin, curculin, glycyrrhizic acid, neohesperidin, dihydrochalcone, glycyrrhizin, glycyphyllin, phloridzin, trilobatin, phyllodulcin, brazzein, hernandulcin, osladin, polypodoside A, baiyunoside, pterocaryoside A and B, mukurozioside, thaumatin, monellin, mabinlins I and II, phlomisoside I, periandrin I, abrusoside A, cyclocarioside I, mogroside IV, mogroside V, saccharin, cyclamate, aspartame, neotame, advantame, acesulfame potassium, sucralose, and combinations thereof.

4. The beverage composition of claim 1, wherein the dairy mineral composition comprises at least 10% by weight potassium.

5. The beverage composition of claim 1, wherein the dairy mineral composition is present in a concentration ranging from about 100 ppm to about 2000 ppm.

6. (canceled)

7. (canceled)

8. The beverage composition of claim 3, further comprising a nutritive sweetener.

9. The beverage composition of claim 3, wherein the beverage composition has fewer than about 200 calories per 8 oz. serving.

10. (canceled)

11. The beverage composition of claim 1, wherein the beverage composition comprises from about 1 ppm to about 400 ppm carbohydrates, from about 2 ppm to about 400 ppm lactose, and from about 0.2 ppm to about 75 ppm calcium.

12. The beverage composition of claim 1 wherein the beverage composition comprises from about 2 ppm to about 400 ppm protein.

13. A method of preparing a beverage composition, the method comprising adding a dairy mineral composition to a carbonated beverage.

14. The method of claim 13, wherein the beverage composition comprises a non-nutritive sweetener.

15. The method of claim 14, wherein the non-nutritive sweetener is selected from the group consisting of a steviol glycoside, Lo Han Guo sweetener, rubusoside, siamenoside, monatin, curculin, glycyrrhizic acid, neohesperidin, dihydrochalcone, glycyrrhizin, glycyphyllin, phloridzin, trilobatin, phyllodulcin, brazzein, hernandulcin, osladin, polypodoside A, baiyunoside, pterocaryoside A and B, mukurozioside, thaumatin, monellin, mabinlins I and II, phlomisoside I, periandrin I, abrusoside A, cyclocarioside I, mogroside IV, mogroside V, saccharin, cyclamate, aspartame, neotame, advantame, acesulfame potassium, sucralose, and combinations thereof.

16. The method of claim 14, wherein the dairy minerals composition comprises at least about 10% by weight potassium.

17. The method of claim 14, wherein the method comprises adding the dairy mineral composition to the carbonated beverage in an amount sufficient to achieve a final concentration of daily mineral composition in the beverage of about 100 ppm to about 2000 ppm.

18. (canceled)

19. (canceled)

20. A method of modifying a flavor attribute in a carbonated beverage, the method comprising adding a dairy mineral composition to the beverage in an amount sufficient to achieve a final concentration of the dairy mineral composition in the beverage of about 100 ppm to about 2000 ppm.
